(19) United States
(12) Patent Application Publication
(10) Pub. No.: US 2022/0108069 A1
(43) Pub. Date: Apr. 7, 2022

(54) DYNAMIC MANAGEMENT OF COMPLIANCE WORKFLOW USING TRAINED MACHINE-LEARNING AND ARTIFICIAL-INTELLIGENCE PROCESSES

(71) Applicant: The Toronto-Dominion Bank, Toronto (CA)

(72) Inventor: Justin Leonard LEE, Toronto (CA)

(21) Appl. No.: 17/483,481

(22) Filed: Sep. 23, 2021

Related U.S. Application Data
(60) Provisional application No. 63/088,853, filed on Oct. 7, 2020.

(51) Int. Cl. G06F 40/279; G06N 5/02; G06N 5/04

(52) U.S. Cl. CPC G06F 40/279; G06F 40/30; G06N 5/04; G06N 5/022

(57) ABSTRACT

The disclosed exemplary embodiments include computer-implemented apparatuses and processes that dynamically manage compliance workflow using trained machine-learning and artificial-intelligence processes. For example, an apparatus may receive, from a device, request data that includes application data associated with a product and compliance data characterizing an activity. The compliance data may include a classification code and textual content, and based on an application of a trained machine-learning or artificial-intelligence process to the classification code and to at least a portion of the textual content, the apparatus may generate output data characterizing a predicted likelihood that the activity complies with a restriction associated with the product. When the output data is inconsistent with at least one compliance criterion, the apparatus may determining a compliance of the activity with the restriction based on additional data associated with the activity and provision the product in accordance with at least a portion of the application data.

### CROSS-REFERENCE TO RELATED APPLICATION

This application claims the benefit of priority to U.S. Provisional Patent Application No. 63/088,853, filed on Oct. 7, 2020, the entire disclosure of which is expressly incorporated herein by reference to its entirety.

### TECHNICAL FIELD

The disclosed embodiments generally relate to computer-implemented systems and processes that dynamically manage compliance workflow using trained machine-learning and artificial-intelligence processes.

### BACKGROUND

Today, financial institutions selectively provision a variety of financial products and services to existing and prospective customers. For example, a prospective business customer of a financial institution may initiate an application for a financial product offered by a financial institution, such as a business checking account, a business credit-card account, or a nosiness-specific line-of-credit, and the prospective business customer may provision, to the financial institution, information that identifies and characterizes the financial product, the prospective business customer, and one or more business activities of the prospective business customer. In some instances, due to various regulations or policies imposed on the financial institution, such as one or more anti-money laundering (AML) regulations or policies, the financial institution may subject the application of the prospective business customer to heightened or enhanced scrutiny prior to approving the application and issuing the financial product to the prospective business customer.

### SUMMARY

In some examples, an apparatus includes a memory storing instructions, a communications interface, and at least one processor coupled to the memory and the communications interface. The at least one processor is configured to execute the instructions to receive request data from a device via the communications interface. The request data includes application data associated with a product and compliance data characterizing an activity, and the compliance data includes a classification code and textual content. The at least one processor is further configured to execute the instructions to, based on an application of a first trained machine-learning or artificial-intelligence process to the classification code and to at least a portion of the textual content, generate output data characterizing a predicted likelihood that the activity complies with a restriction associated with the product. The at least one processor is further configured to execute the instructions to, when the output data is inconsistent with at least one compliance criterion, determine a compliance of the activity with the restriction based on additional data associated with the activity, and based on the determined compliance, perform operations that provision the product in accordance with at least a portion of the application data.

In other examples, a computer-implemented method includes receiving request data from a device using at least one processor. The request data includes application data associated with a product and compliance data characterizing an activity, and the compliance data includes a classification code and textual content. Based on an application of a first trained machine-learning or artificial-intelligence process to the classification code and to at least a portion of the textual content, the computer-implemented method also includes generating, using the at least one processor, output data characterizing a predicted likelihood that the activity complies with a restriction associated with the product. When the output data is inconsistent with at least one compliance criterion, the computer-implemented method includes determining, using the at least one processor, a compliance of the activity with the restriction based on additional data associated with the activity, and based on the determined compliance, performing operations, using the at least one processor, that provision the product in accordance with at least a portion of the application data.

Further, in some examples, a tangible, non-transitory computer-readable medium storing instructions that, when executed by at least one processor, cause the at least one processor to perform a method that includes receiving request data from a device. The request data includes application data associated with a product and compliance data characterizing an activity, and the compliance data includes a classification code and textual content. The method also includes, based on an application of a first trained machine-learning or artificial-intelligence process to the classification code and to at least a portion of the textual content, generating output data characterizing a predicted likelihood that the activity complies with a restriction associated with the product. The method also includes, when the output data is inconsistent with at least one compliance criterion, determining a compliance of the activity with the restriction based on additional data associated with the activity, and based on the determined compliance, performing operations that that provision the product in accordance with at least a portion of the application data.

The details of one or more exemplary embodiments of the subject matter described in this specification are set forth in the accompanying drawings and the description below. Other potential features, aspects, and advantages of the subject matter will become apparent from the description, the drawings, and the claims.

### BRIEF DESCRIPTION OF THE DRAWINGS

FIG. 1 is a diagram of an exemplary computing environment, consistent with disclosed exemplary embodiments;

FIGS. 2, 3A, and 3B are diagrams illustrating portions of an exemplary computing environment, consistent with disclosed exemplary embodiments;

FIG. 3 is a diagram illustrating portions of an exemplary computing environment, consistent with disclosed exemplary embodiments; and

FIG. 4 is a flowchart of an exemplary process for dynamically managing compliance workflow using trained machine-learning or artificial-intelligence processes, consistent with disclosed exemplary embodiments.

### DETAILED DESCRIPTION

Today, financial institutions provision a variety of financial products to prospective or existing customers, either through in-person, branch-based appointments or through one or more digital channels. As described herein, the provisioned financial products may include one or more business accounts that, upon issuance to a prospective or existing business customer, may fund or receive proceeds from one or more business activities of the prospective or existing business customer, and examples of the one or more business accounts may include, but are not limited to, a business checking account, a business credit-card account, or a business-specific line-of-credit, each of which may be issued by the financial institution in accordance with determined terms and conditions. In some instances, due to a regulatory environment in which many financial institutions operate, prospective business customers of these financial institutions often face heightened or enhanced regulatory scrutiny when opening new business accounts at the financial institutions.

By way of example, to comply with one or more currently imposed anti-money laundering (AML) regulations or policies, a financial institution may assesses, for a prospective business customer, a potential risk (e.g., a potential “AML risk”) that funds deposited within a newly opened business account, such as a business checking account, are associated with, result from, or are derived from money laundering or other activities identified and prohibited by the currently imposed AML regulations or policies. If the financial institution were to determine that a relationship with the prospective business banking customer represents, or poses, a potential AML risk to the financial institution under the currently imposed AML regulations or policies, the financial institution may performs additional diligence to better understand the business activities and revenue sources of the prospective business customer, and to establish whether a relationship between the financial institution and the prospective business customer represents an actual AML risk to the financial institution under the currently imposed AML regulations or policies, and/or would render the financial institution non-compliant with the currently imposed AML regulations or policies.

To facilitate an assessment of the AML risk associated with a relationship between a prospective business customer and a financial institution, the financial institution may obtain, during an application process for new business account (e.g., either through an in-person, branch-based appointment or through one or more digital channels, such as a web page), not only information that identifiers the prospective business customers and the new business account, but also information that characterizes one or more business activities of that prospective business customer. For example, the prospective business customer may provide, to the financial institution, a numerical classification code associated with the corresponding business activities, such as, but not limited to, a standard industrial classification (SIC) code assigned to the industry in which the prospective business customer operates or a merchant category code (MCC) associated with the prospective business customer. In some instances, when evaluating the application of the prospective business customer for the new business account, a representative of the financial institution may access the provisioned numerical classification code (e.g., the SIC code or the MCC described herein), Based on the provisioned numerical classification code and on other elements of provisioned application data, and in view of an experience or intuition of the representative or one or more internal guidelines established by the financial institution, the representative may assign a level of AML risk to the prospective business customer, and may either establish a need for additional diligence associated with the prospective business customer or approve the application of the prospective business customer for the business account.

In some instances, the representative's reliance on the numerical classification code (e.g., the SIC code, the MCC, etc.) to assign the level of AML risk to the prospective business customer may inaccurately capture the actual AML risk posed to the financial institution by the relationship with prospective business customer, either through an underestimation, or alternatively, an exaggeration, of the actual AML risk posed by the business activities of the prospective business customer. By way of example, SIC code 5944 characterizes businesses associated with the retail sale of jewelry and precious stones. While a prospective business customer engaged in the retail sale of jewelry and precious stones could represent an actual AML risk to the financial institution, the level of AML risk associated with a relationship with the prospective business customer may vary widely depending on the actual business activities engaged in by the prospective business customer.

For example, a prospective business customer associated with SIC code 5944 could engage in the appraisal of vintage jewelry or in the design of customer jewelry on commission, and these business activities would pose a minimal AML risk to the financial institution. In other examples, a prospective business customer associated with SIC code 5944 may engage in the sale of jewelry to retail customers, which may pose an average, but acceptable, AML risk to the financial institution. Further, an additional prospective business customer of the financial institution may be associated with SIC code 5944, but may engage in the purchase and sale of precious metals and raw, uncut stones on the wholesale market, which may pose an unacceptably high AML risk to the financial institution. In some instances, when relying on the SIC code (or other numerical classification code) associated with a prospective business customer, even in conjunction with the representative's own experience or intuition and internal guidelines of the financial institution, the representative of the financial institution may be incapable of reconciling the provisioned SIC code with the actual business activities of the prospective customer, and may lack certainty that the actual business activities of the prospective business customer are consistent with the provisioned SIC code, and not with other business activities inconsistent with the AML regulations or policies imposed on the financial institution.

Many of the compliance workflow processes implemented by financial institutions, which rely on the numerical classification codes described herein to assess and assign AML risk to relationships with prospective business customers, may be incapable of accounting for gradations in the AML risk across prospective business customer associated with a common SIC code. These existing compliance workflow processes may establish improperly a need for additional diligence to understand the business activities of a prospective business customers associated with a minimal AML risk to the financial institution, while declining improperly a performance of additional diligence for prospective business customers engaged in business activities that pose an actual, heightened AML risk to the financial institution. Further, by improperly assessing or classifying an AML risk associated with prospective business customers whose activities are inconsistent with the imposed AML regulations or policies, these existing compliance workflow processes may increase a likelihood that a financial institution will be impacted by fraudulent activities involving these improperly assessed or classified business customers.

Moreover, a financial institution, and computing systems operated by the financial institution, may implement these compliance workflow processes thousands of times on a daily basis during an evaluation of applications of prospective business customers for business accounts, products, or services offered by the financial institutions. A manual evaluation of these applications by representatives of the financial institution may, in some instances, result in a broad dissemination of confidential information provided by the prospective business customers across the financial institution, which may increase a likelihood of unintentional, or intentional, disclosures of the confidential information to third-parties, and which may increase a likelihood of fraudulent activity involving the disclosed confidential information.

Further, when implemented programmatically by the computing systems of the financial institution, these compliance workflow processes may cause the computing systems to establish communications with programmatic interfaces associated with, or maintained, by network-connected data repositories, and to request and receive additional information characterizing the business activities of the prospective business customers of the financial institutions (e.g., in support of the additional diligence associated with corresponding ones of the applications for the business accounts, products, or services). By improperly identifying those prospective business customers, and corresponding applications for business accounts, that are subject to additional diligence, the programmatic implementation of these existing compliance workflow processes by the computing systems of the financial institution may results in an unnecessary exposure of the programmatic interfaces of the network-connected data repositories to across potentially insecure communications channels, which may increase a likelihood of attacks by, or fraudulent activity involving, malicious third parties. Further, the computational operations to request and receive the additional information in support the additional diligence of low-AML risk customers, and the need to store the additional information for each of these low-AML risk customers, reduces an efficiency of the computing systems of the financial institution and results in an uneven, and unnecessary, allocation of computational and storage resources at these computing systems.

Certain of the exemplary processes described herein, which dynamically manage compliance workflow using trained machine-learning or artificial processes, may, upon implementation by a computing system of a financial institution, and in support of an application of a prospective business customer for a business account, enable the computing system to obtain elements of compliance data that include not only a numerical classification code associated with the prospective business customer, but also elements of natural language specified by the prospective business customer and characterizing one or more actual business activities of that prospective business customer. Based on an application of a trained natural language processing (NLP) operations to the elements of natural language, the computing system of the financial institution may decompose the elements of natural language into one or more keywords that represent the actual business activities of the prospective business customer.

Further, and through an application of a trained machine-learning or artificial-intelligence process to the numerical classification code and to at least a subset of the keywords, the computing system of the financial institution may generate a value of one or more metrics that characterize not only a consistency between the numerical classification code and the actual business activities of the prospective business customer, but also characterize a predicted likelihood that the prospective business customer, or the issuance of the business product to the prospective business customer, pose an actual AML risk to the financial institution. Certain of these exemplary, dynamic processes for managing compliance workflow, as described herein, may be implemented in addition to, or as an alternate to, many existing compliance workflow processes, which characterize AML risk based on numerical classification codes assigned to prospective business customers in conjunction with a representative's experience or intuition, or in conjunction with internal guidelines promulgated by the financial institution.

### I. Exemplary Computing Environments

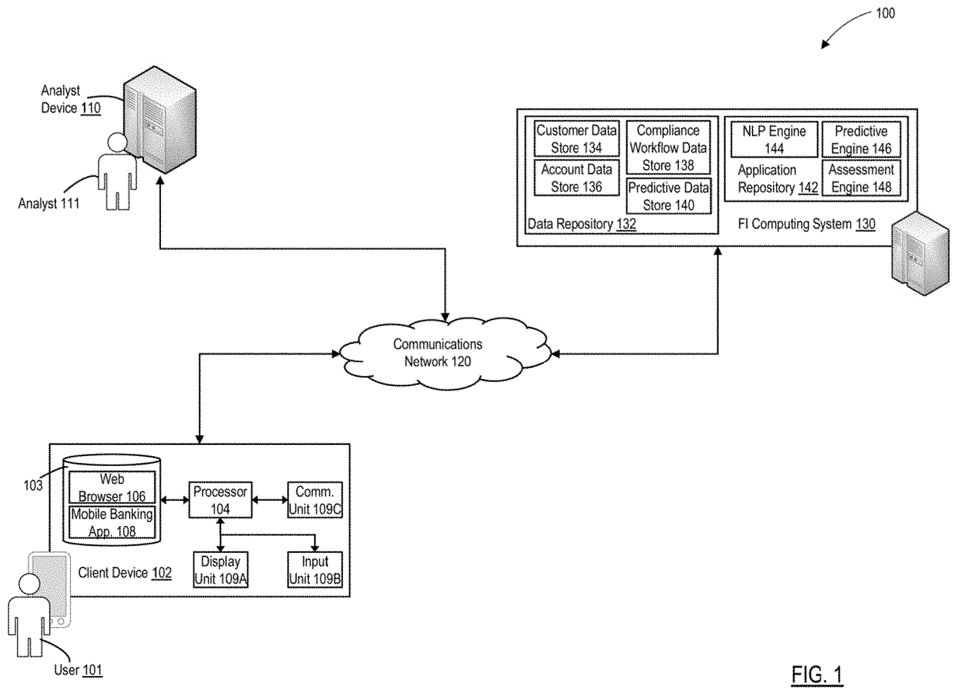

FIG. 1 is a diagram illustrating an exemplary computing environment 100 that includes, among other things, one or more computing devices, such as a client device 102 and an analyst device 112, and one or more computing systems, such as a financial institution (FI) computing system 130, each of which may be operatively connected to, and interconnected across, one or more communications networks, such as communications network 120. Examples of network 120 include, but are not limited to, a wireless local area network (LAN), e.g., a “Wi-Fi” network, a network utilizing radio-frequency (RF) communication protocols, a Near Field Communication (NFC) network, a wireless Metropolitan Area Network (MAN) connecting multiple wireless LANs, and a wide area network (WAN), e.g., the Internet.

Client device 102 may include a computing device having one or more tangible, non-transitory memories, such as memory 103, that store data and/or software instructions, and one or more processors, e.g., processor 104, configured to execute the software instructions. The one or more tangible, non-transitory memories may, in some instances, store application programs, application engines or modules, and other elements of code executable by the one or more processors, such as, but not limited to, an executable web browser 106 (e.g., Google Chrome™, Apple Safari™, etc.), and additionally or alternatively, an executable application associated with FI computing system 130, such as mobile banking application 108. In some instances, not illustrated in FIG. 1, memory 103 may also include one or more structured or unstructured data repositories or databases, and client device 102 may maintain one or more elements of device data within the one or more structured or unstructured data repositories or databases. For example, the elements of device data may uniquely identify client device 102 within computing environment 100, and may include, but are not limited to, an Internet Protocol (IP) address assigned to client device 102 or a media access control (MAC) layer assigned to client device 102.

Client device 102 may also include a display unit 109A configured to present interface elements to a corresponding user, such as a user 101, and an input unit 109B configured to receive input from user 101, e.g., in response to the interface elements presented through display unit 109A. By way of example, display unit 109A may include, but is not limited to, an LCD display unit or other appropriate type of display unit, and input unit 109B may include, but is not limited to, a keypad, keyboard, touchscreen, voice activated control technologies, or appropriate type of input unit. Further, in additional instances (not illustrated in FIG. 1), the functionalities of display unit 109A and input unit 109B may be combined into a single device, e.g., a pressure-sensitive touchscreen display unit that presents interface elements and receives input from user 101. Client device 102 may also include a communications interface 109C, such as a wireless transceiver device, coupled to processor 104 and configured by processor 104 to establish and maintain communications with communications network 120 via one or more communication protocols, such as WiFi®, Bluetooth®, NFC, a cellular communications protocol (e.g., LTE®, CDMA®, GSM®, etc.), or any other suitable communications protocol.

Further, although not illustrated in FIG. 1, analyst device 112 may also include a computing device having one or more tangible, non-transitory memories that store data and/or software instructions, and one or more processors configured to execute the software instructions. The one or more tangible, non-transitory memories may, in some instances, store application programs, application engines or modules, and other elements of code executable by the one or more processors, such as, but not limited to, the executable web browsers and the executable mobile banking applications described herein. Further, analyst device 112 may also include a display unit configured to present interface elements to a corresponding user, such as an analyst 111, and an input unit configured to receive input from analyst 111, e.g., in response to the interface elements presented through the corresponding display unit. As described herein, examples, of the display unit may include, but are not limited to, an LCD display unit or other appropriate type of display unit, and examples of the input unit may include, but is not limited to, a keypad, keyboard, touchscreen, voice activated control technologies, or appropriate type of input unit. In some instances, the functionalities of the display and interface units of analyst device 112 may be combined into a single device, e.g., a pressure-sensitive touchscreen display unit that presents interface elements and receives input from analyst 111. Further, analyst device 112 may also include a communications interface, such as a wireless transceiver device, coupled to, and configured by, the one or more processors to establish and maintain communications with communications network 120 via one or more communication protocols, such as WiFi®, Bluetooth®, NFC, a cellular communications protocol (e.g., LTE®, CDMA®, GSM®, etc.), or any other suitable communications protocol.

Examples of client device 102 and analyst device 112 may include, but not limited to, a personal computer, a laptop computer, a tablet computer, a notebook computer, a hand-held computer, a personal digital assistant, a portable navigation device, a mobile phone, a smart phone, a wearable computing device (e.g., a smart watch, a wearable activity monitor, wearable smart jewelry, and glasses and other optical devices that include optical head-mounted displays (OHMDs)), an embedded computing device (e.g., in communication with a smart textile or electronic fabric), and any other type of computing device that may be configured to store data and software instructions, execute software instructions to perform operations, and/or display information on an interface device or unit, such as display unit 109A. In some instances, user 101 may operate client device 102 and may do so to cause client device 102 to perform one or more exemplary processes described herein, and analyst 111 may operate analyst device 112 and may do so to cause analyst device 112 to perform one or more exemplary processes described herein.

In some examples, FI computing system 130 may correspond to a discrete computing system that includes one or more servers and tangible, non-transitory memories storing executable code and application modules. The one or more servers may each include one or more processors, which may be configured to execute portions of stored code or application modules and perform operations consistent with the disclosed embodiments, and the one or more processors may include a central processing unit (CPU) capable of processing a single operation (e.g., a scalar operation) in a single clock cycle. Further, although not illustrated in FIG. 1, FI computing system 130 may also include a communications interface, such as one or more wireless transceiver devices, that are coupled to the one or more processors for accommodating wired or wireless internet communication with other computing systems and devices operating within environment 100.

In other examples, FI computing system 130 may correspond to a distributed computing system having a plurality of interconnected, computing components distributed across an appropriate computing network, such as communications network 120 of FIG. 1. For example, FI computing system 130 may correspond to a distributed or cloud-based computing cluster associated with, and maintained by, the financial institution, although in other examples, FI computing system 130 may correspond to a publicly accessible, distributed or cloud-based computing cluster, such as a computing cluster maintained by Microsoft Azure™, Amazon Web Services™, Google Cloud™, or another third-party provider, or across a private, distributed or cloud-based computing cluster established and maintained by the financial institution.

For instance, FI computing system 130 may include a plurality of interconnected, distributed computing components, such as those described herein (not illustrated in FIG. 1), which may be configured to implement one or more parallelized, fault-tolerant distributed computing and analytical processes (e.g., an Apache Spark™ distributed, cluster-computing framework, a Databricks™ analytical platform, etc.). Further, and in addition to the CPUs described herein, the distributed computing components of FI computing system 130 may also include one or more graphics processing units (GPUs) capable of processing thousands of operations (e.g., vector operations) in a single clock cycle, and additionally, or alternatively, one or more tensor processing units (TPUs) capable of processing hundreds of thousands of operations (e.g., matrix operations) in a single clock cycle. Through an implementation of the parallelized, fault-tolerant distributed computing and analytical protocols described herein, the distributed computing components of FI computing system 130 may perform any of the exemplary processes described herein to pre-process and maintain elements of customer, account, and/or compliance workflow data within an accessible data repository (e.g., within a portion of a distributed file system, such as a Hadoop distributed file system (HDFS)).

Further, and through an implementation of the parallelized, fault-tolerant distributed computing and analytical protocols described herein, the distributed components of FI computing system 130 may perform operations in parallel that not only train adaptively a machine learning or artificial intelligence process using corresponding training and validation datasets extracted from temporally distinct subsets of preprocessed data elements, but also apply the adaptively trained machine learning or artificial intelligence process to customer-specific input datasets that include portions of the pre-processed elements of customer, account, and/or compliance workflow data. Based on the application of the adaptively trained machine learning or artificial intelligence process to the customer-specific input datasets, the distributed components of FI computing system 130 may perform operations that generate customer-specific elements of output data indicative of a predicted likelihood that a prospective business customer represents an AML risk to the financial institution. The disclosed embodiments are, however, not limited to these exemplary distributed systems, and in other instances, FI computing system 130 may include computing components disposed within any additional or alternate number or type of computing systems or across any appropriate network.

In some instances, FI computing system 130 may be associated with, or operated by, a financial institution, which may issue one or more financial services accounts (e.g., “business” accounts) to a prospective business customer, such as user 101. Examples of the one or more business accounts may include, but are not limited to, a deposit account, such as a business checking account, capable of receiving proceeds derived from the activities of corresponding business customer, a business credit-card account, or a business-specific line-of-credit. Further, FI computing system 130 institution may perform operations, described herein, that implement one or more application and compliance workflows application with an application, of the prospective business customer, for business account offered by the financial institution, and that issue the business account to the prospective business customer business customer upon successful completion of one or more application and compliance workflows.

The application and compliance workflows may, for example, include an assessment of a compliance of the prospective business customer, and the application for the business account by that prospective business customer, with one or more anti-money laundering (AML) regulations or policies imposed currently on the financial institution. By way of example, to assess a compliance of the prospective business customer, and the application for the business account, with the currently imposed AML regulations or policies, FI computing system 130 may determine, for the prospective business customer and the corresponding application for the business account, a value of one or more metrics that characterize, individually or collectively, a likelihood that funds deposited within the business account would be associated with, result from, or by derived from money laundering or other activities identified and prohibited by the AML regulations or policies.

In some instances, and in support of the application for the business account by the prospective business customer, FI computing system 130 may obtain elements of data that characterize an industry in which the prospective business customer operates, such as, but not limited to, a four-digital standard industrial classification (SIC) code, and elements of natural language that characterize one or more actual business activities of the prospective business customer, such as, but not limited to, a text string provisioned as input by user 101 to client device 102. Based on an application of a trained natural language processing (NLP) operation to the elements of natural language, FI computing system 130 may perform any of the exemplary processes described herein to generate a set of keywords representative of the actual business activities of the prospective business customer. Further, FI computing system 130 may perform operations, described herein, to generate an input dataset that includes the SIC code and at least a subset of keywords, and based on an application of a trained machine-learning or artificial-intelligence process to the input dataset, FI computing system 130 may generate elements of output data indicative of a predicted likelihood that the prospective business customer, and the issuance of the business account to the prospective business customer, pose an AML risk to the financial institution. Based on a comparison between elements of output data and one or more compliance criteria, FI computing system 130 perform operations that complete successfully the application and compliance workflows described herein and issue the business account to the prospective business customer, or alternatively, that flag the prospective business customer and the corresponding applications for the business account for a performance of additional diligence, e.g., prior to issuing the business account to the prospective business customer.

To facilitate the performance of any of the exemplary processes described herein, FI computing system 130 may maintain, within one or more tangible, non-transitory memories, a data repository 132 that includes, among other things, a customer data store 134, an account data store 136, a compliance workflow data store 138, and a predictive data store 140. In some instances, customer data store 134 may include a plurality of data records associated with, and characterizing, corresponding ones of the customers of the financial institution. By way of example, and for a particular customer of the financial institution, the data records of customer profile data 104A may include, but are not limited to, one or more unique customer identifiers (e.g., an alphanumeric character string, such as a login credential, a customer name, etc.), residence data (e.g., a street address, etc.), other elements of contact data (e.g., a mobile number, an email address, etc.), values of demographic parameters that characterize the particular customer (e.g., ages, occupations, marital status, etc.), and other data characterizing the relationship between the particular customer and the financial institution. In some instances, the data records of customer data store 134 may also include, for the particular customer, device data that uniquely identifies one or more devices associated with or operated by the particular customer (e.g., a unique device identifier, such as an IP address, a MAC address, a mobile telephone number, etc.).

Account data store 136 may also include a plurality of data records that identify and characterize one or more financial products issued by the financial institution to corresponding ones of the customers. For example, the data records of account data 104B may include, for each of the financial products issued to corresponding ones of the customers, one or more identifiers of the financial product (e.g., an account number, expiration data, card-security-code, etc.), one or more unique customer identifiers (e.g., an alphanumeric character string, such as a login credential, a customer name, etc.), information identifying a product type that characterizes the issued financial product (e.g., the business checking account described herein), and additional information characterizing a balance or current status of the financial product (e.g., payment due dates or amounts, delinquent accounts statuses, etc.).

Compliance workflow data store 138 may include data records that maintain discrete product requests received by FI computing system 130 using any of the exemplary processes described herein. As described herein, each of the elements of account request data may be associated with a corresponding application of a prospective business customer to obtain one or more business accounts issuable by the financial institution, and each of the products requests may include may include, among other things, one or more elements of application data and one or more elements of compliance data. For example, and for a particular one of the product requests, and for an application by a corresponding one of the prospective business customers (e.g., user 101), the elements of application data may identify, and characterize, the requested business account, the prospective business customer, and a business operated by the prospective business customer. Further, and for the particular product request, and for the application of the prospective business customer, the elements of compliance data may identify and characterize an industry associated with the business operated by the prospective business customer and the actual business activities of the prospective business customer and the operated business.

As described herein, the elements of compliance data may include, among other things, a numerical classification code associated with the business operated by the corresponding one of the prospective business customers, and a text string that characterizes one or more actual business activities of the business. Examples of the numerical classification code may include, but are not limited to, a four-digit SIC code assigned to the industry, a four-digit MCC that classifies the business, or any additional, or alternate, industry-, merchant-, product-, or service-specific numerical classification code that characterizes the business operated by the prospective business customers or the business activities of the prospective business customer and the operated business. Further, the text string maintained within the elements of compliance data may include one or more elements of natural language that describe the actual business activities of the prospective business customer and the operated business, such as, but not limited to, sentence, a phrase, or other portion of a sentence, e.g., as provisioned as input by the corresponding one of the prospective business customers to a digital interface presented at a corresponding device.

In some instances, and for each of the prospective business customers and the corresponding application for the requested business account, the data records of compliance workflow data store 138 may maintain a corresponding product request in conjunction with corresponding elements of keyword data, which include one or more keywords derived from the corresponding elements of natural language and are representative of the actual business activities of prospective business customer, and corresponding elements of output data, which characterize a predicted likelihood that the prospective business customer, or the issuance of the corresponding requested business account, pose an AML risk to the financial institution. As described herein, and for a corresponding one of the prospective business customers, the elements of output data may include a value of one or more metrics that characterize, individually or collectively, the predicted likelihood that the prospective business customer poses an AML risk to the financial institution (e.g., a predicted likelihood that funds deposited within the corresponding one of the requested business accounts would be associated with, result from, or by derived from money laundering or other activities identified and prohibited by the AML or compliance regulations imposed on the financial institution). In some examples, the data records of compliance workflow data store 138 may also maintain, for each of the prospective business customers and the corresponding application for the requested business accounts, information that, in conjunction with the product request and the outcome data, flags the corresponding application for a performance of additional diligence operations prior to approving the corresponding application for the requested business account.

In some instances, FI computing system 130 may also maintain, within the one or more tangible, non-transitory memories, an application repository 142 that includes one or more executable application programs, such as, but not limited to, a natural language processing (NLP) engine 144, a predictive engine 146, and an assessment engine 148. By way of example, and upon execution by the one or more processors of FI computing system 130, NLP engine 144 may perform any of the exemplary processes described herein to apply an NLP operation to elements of natural language that characterize the actual activities of a prospective business customer of the financial institution (e.g., a text string maintained with the elements of compliance data within a corresponding one of the applications for the requested business accounts, as described herein). Based on the application of the NLP operation to the elements of natural language, executed NLP engine 144 may perform any of the exemplary processes described herein to parse the elements of natural language, identify one or more discrete linguistic elements (e.g., a word, a combination of morphemes, a single morpheme, etc.), and generate one or more keywords that, individually or collectively, are representative of the actual business activities of the prospective business customer.

Examples of the NLP operation may include one or more trained machine-learning processes, such as, but not limited to, a trained clustering algorithm, a trained unsupervised learning algorithm (e.g., a k-means algorithm, a mixture model, a hierarchical clustering algorithm, etc.), or a trained, semi-supervised learning algorithm. In other examples, the NLP operation may also include one or more trained, artificial-intelligence processes, such as, but not limited to, an artificial neural network model, a deep neural network, a decision-tree algorithm (e.g., a boosted, decision-tree algorithm), a recurrent neural network model, a Bayesian network model, or a Markov model. The NLP operation may also include one or more adaptively trained statistical processes, such as those that make probabilistic decisions based on attaching real-valued weights to elements of certain input data. Further, in some examples, the NLP operation may also include one or more text parsing algorithms or processes, such as, but not limited to, a top-down parser (e.g., a recursive descent parser, a non-recursive descent parser), a bottom-up parser (e.g., an LR parser, an operator precedence parser, etc.), or an operator precedence parsers.

Certain of these exemplary NLP operations, including the exemplary adaptive statistical processes, machine learning processes, or artificial intelligence processes described herein, may be trained against, and adaptively improved using, elements of training and validation data having a specified composition, which may be extracted from portions of compliance workflow data store 138, and may be deemed successfully trained and ready for deployment when a value of one or more performance or accuracy metrics exceeds a predetermined threshold value. By way of example, FI computing system 130 may perform operations generate the elements of training data based on elements of compliance workflow data store 138 associated with a first temporal interval, and may generate the elements of validation data based on additional elements of compliance workflow data store 138 associated with a second temporal interval distinct from the first temporal interval, as described herein.

Further, when executed by the one or more processors of FI computing system 130, executed predictive engine 146 may perform any of the exemplary processes described herein to generate an input dataset that includes, among other things, the numerical classification code (e.g., the SIC code described herein) and at least a subset of the keywords representative of the actual business activities of the prospective business customer, and to apply a trained machine-learning or artificial-intelligence process to the generated input dataset. Based on the application of the trained machine-learning or artificial-intelligence process to the input dataset, executed predictive engine 146 may perform any of the exemplary processes described herein to generate one or more elements of output data that, individually or collectively, indicate a predicted likelihood that the prospective business customer, and the issuance of the business account to the prospective business customer, poses an AML risk to the financial institution.

As described herein, the elements of output data may include of one or more metrics that, individually or collectively, indicate the predicted likelihood that the prospective business customer, and the issuance of the business account to the prospective business customer, poses an AML risk to the financial institution. In some instances, at least one of the metric values may include a numerical value ranging from zero (e.g., a minimal predicted likelihood) to unity (e.g., a maximum predicted likelihood). Further, in some instances, the one or more metric values may include an additional numerical value indicative of determined level of consistency between (i) the classification code obtained from the elements of account request data and (ii) the keywords derived from the elements of natural language that characterize the actual business activities of the prospective business customer (e.g., e.g., with a value of zero indicating a minimal inconsistency, and with a value of unity indicating a maximum inconsistency, etc.). For example, a determined inconsistency between the classification code and the keywords may be indicative of an intent, by the prospective business customer, to deceive the financial institution regarding the true nature of the business activities of the prospective business customer, and may indicate that the prospective business customer poses a heightened AML risk to the financial institution

Examples of the trained machine-learning and artificial-intelligence processes may include, but are not limited to, a clustering process, an unsupervised learning process (e.g., a k-means algorithm, a mixture model, a hierarchical clustering algorithm, etc.), a semi-supervised learning process, a supervised learning process, or a statistical process (e.g., a multinomial logistic regression model, etc.). The trained machine-learning and artificial-intelligence processes may also include, among other things, a decision tree process (e.g., a boosted decision tree algorithm, etc.), a random decision forest, an artificial neural network, a deep neural network, or an association-rule process (e.g., an Apriori algorithm, an Eclat algorithm, or an FP-growth algorithm). Further, and as described herein, each of these exemplary machine-learning and artificial-intelligence processes may be trained against, and adaptively improved using, elements of training and validation data, and may be deemed successfully trained and ready for deployment when a value of one or more performance or accuracy metrics are consistent with one or more threshold training or validation criteria

For example, FI computing system 130 may perform operations that identify, within compliance workflow data store 138, a subset of the data records maintaining elements of product request data received by FI computing system 130 during a prior temporal interval, and that partition the prior temporal interval into a training interval and a separate, and distinct, validation interval. FI computing system 130 may also generate one or more training datasets having various compositions based on the elements of product request data (e.g., the classification code) and keyword data (e.g., one or more of the keywords) maintained within the data records associated with the training interval, and may perform operations that train the machine-learning and artificial-intelligence process based on the generated training datasets, that compute a value of one or more performance or accuracy metrics that characterize the machine-learning and artificial-intelligence process (e.g., based on a comparison between the newly generated and store elements, etc.), and that, based on a determination that the computed values are consistent with the one or more threshold training criteria (e.g., one or more of the computed values exceeds a predetermined threshold value, etc.), generate model data that specifies one or more parameters of the trained machine-learning and artificial-intelligence process (e.g., a tree depth, a number of nodes, etc.) and composition data that specifies a composition of the corresponding input dataset.

FI computing system 130 may also perform operations that, based on the elements of account request data (e.g., the classification code) and keyword data (e.g., one or more of the keywords) maintained within the data records associated with the validation interval, generate one or more validation dataset structured in accordance with the input data, and that apply the trained machine-learning or artificial-intelligence process to each of the one or more validation datasets. Based on the application of the trained machine-learning or artificial-intelligence process to each of the one or more validation datasets, FI computing system 130 may generate additional elements of output data, and that compute additional values of the one or more performance or accuracy metrics using any of the exemplary processes described herein. Based on a determination that the computed additional values are consistent with the one or more threshold validation criteria (e.g., one or more of the computed values exceeds a predetermined threshold value, etc.), FI computing system 130 may validate the trained machine-learning or artificial-intelligence process and deem the trained machine-learning or artificial-intelligence process ready for deployment (or alternatively, FI computing system 130 may further tune the parameters of the trained machine-learning or artificial-intelligence process based on a determined inconsistency between the computed additional values and the one or more threshold validation criteria).

Referring back to FIG. 1, and upon execution by the one or more processors of FI computing system 130, assessment engine 148 may perform any of the exemplary processes described herein that, based on a comparison between the elements of output data associated with the prospective business customer and one or more compliance criteria, determine whether the prospective business customer represents a potential AML risk to the financial institution, and further, whether the to perform additional diligence that further characterizes the prospective business customer and the business activities of the prospective business customer, e.g., prior to approving the corresponding application of the prospective business customer for the requested business account. As described herein, the elements of output data associated with the prospective business customer may include a value of one or more metrics that, individually or collectively, indicate a predicted likelihood that the prospective business customer, and the issuance of the requested business account to the prospective business customer, represents a potential AML risk to the financial institution (e.g., a numerical value ranging from zero to unity, etc.). In some examples, the one or more compliance criteria may include a predetermined or dynamically determined threshold value, and executed assessment engine 148 may determine that the prospective business customer represents a potential AML risk to the financial institution when the numerical value exceeds the predetermined or dynamically determined threshold value.

In some instances, executed assessment engine 148 may establish a predetermined threshold value for the prospective business customer based on one or more characteristics of the prospective business customer, such as, but not limited to, a corresponding business type, a corresponding classification code, a corresponding stream of revenue, a corporate structure, or a geographic parameter (e.g., a state of incorporation, a state of residence, etc.), or based on data characterizing the behavior of similar business customers of the financial institution. Further, in some instances, executed assessment engine 148 may perform operations that determine dynamically the threshold value for the prospective business customer in accordance with a particular temporal schedule, based on and responsive to a detected change in one or more of the characteristics of the prospective business customer, and/or based on changes in the behavior of the similar business customers.

### II. Exemplary Computer-Implemented Processes for Dynamically Managing Compliance Workflow Using Trained Machine-Learning or Artificial-Intelligence Processes

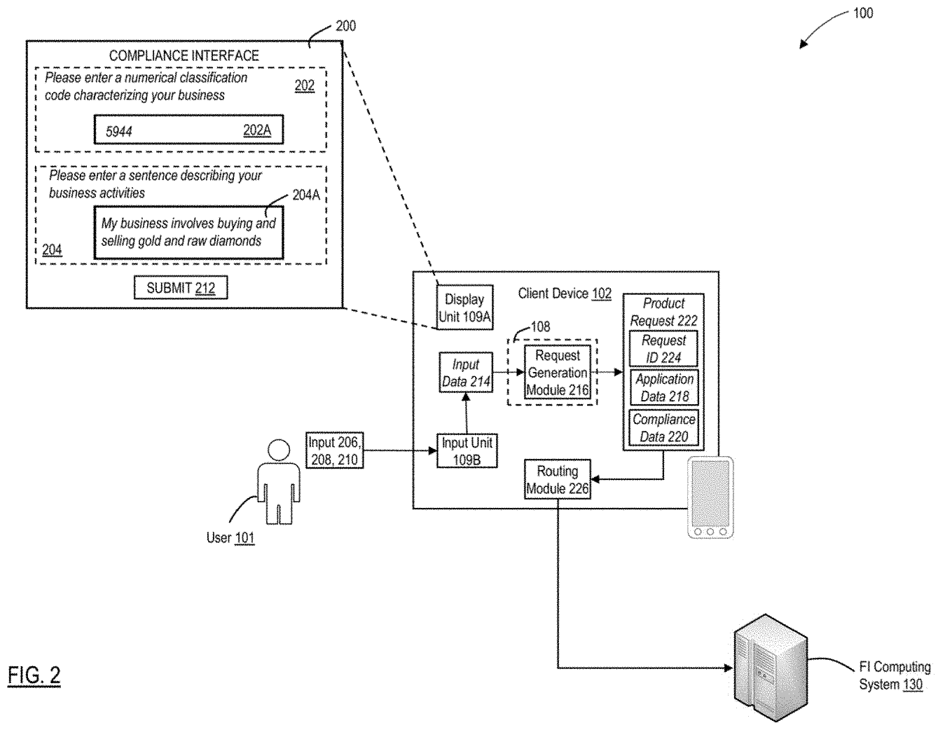

In some instances, a prospective business customer of the financial institution, such as user 101, may elect to request access to one or more financial products or services offered and issued by a financial institution, such as, but not limited to, a business account offered by the financial institution associated with FI computing system 110. By way of example, user 101 may operate a local business in Washington, D.C., that, among other things, trades in raw diamonds and gold, and user 101 may elect to apply for a business checking account offered by the financial institution. Upon execution by processor 104 of client device 102, an executed application program, such as web browser 106 or executed mobile banking application 108, may perform operations that present, via display unit 109A, a digital interface, such as digital interface 200 of FIG. 2, which enables user 101 to access a web page or other digital portal of the financial institution, and initiate an application for the business checking account offered by the financial institution.

By way of example, and based on interface elements presented within digital interface 200, user 101 may provide input to input unit 109B that, among other things, identifies and characterizes the business checking account (e.g., a product or account type, etc.), user 101 (e.g., a full name and street address of user 101, a date of birth of user 101, and/or a governmental identifier assigned to user 101, such as a driver's license number or a social security number, etc.), the local business operated by user 101 (e.g., a full name and business address of the local business, an identifier assigned to the local business by a governmental entity, such as an employer identification number (EIN), or a state of incorporation of the local business, such as Washington, D.C., etc.), and the business account (e.g., a product type of the business checking account, etc.). Further, upon provisioning of the input identifying and characterizing the business checking account, user 101, and the local business, executed mobile banking application 108 (or executed web browser 106) may perform operations that generate, and present within digital interface 200, one or more additional interface elements that prompt user 101 to provide, via input unit 109B, further input that characterizes the industry associated with the local business operated by user 101 and the actual business activities of the local business operated by user 101. In some instances, the additional input provisioned by user 101 may correspond to, and specify, one or more elements of compliance data that, when processed by FI computing system 130 using any of the exemplary processes described herein, enables FI computing system 130 to generate a value of a metric indicative of a predicted likelihood that an issuance of the business checking account to user 101 would represent a potential AML risk to the financial institution, and further, to establish a compliance of user 101, and the issuance of the requested business checking account, with the current AML regulations imposed on the financial institution.

Referring to FIG. 2A, executed mobile banking application 108 (or executed web browser 106) may perform operations that cause client device 102 to present, within digital interface 200 via display unit 109A, additional interface elements 202 that prompt user 101 to provide input, to an interactive text box 202A, a numerical classification code assigned to, or that characterizes, the industry associated with the local business operated by user 101. By way of example, and as described herein, the numerical classification code may include, but is not limited to, a four-digital SIC code assigned to the industry, a four-digit MCC that classifies the local business, or any additional, or alternate, industry-, merchant-, product-, or service-specific numerical classification code that characterizes the local business operated by user 101 or the business activities of the local business operated by user 101. Further, as illustrated in FIG. 2A, executed mobile banking application 108 (or executed web browser 106) may also perform operations that cause client device 102 to present, within digital interface 200 via display unit 109A, additional interface elements 204 that prompt user 101 to provide, as input to an interactive text box 204A, a text string characterizing the actual business activities of the local business operated by user 101. In some instances, the text string may correspond to one or more elements of natural language that describe the actual business activities of the local business, such as, but not limited to, sentence, a phrase, or other portion of a sentence provisioned by user 101 to interactive text box 204A, e.g., via input unit 109B of client device 102.

By way of example, SIC code 5944 characterizes establishments engaged primarily in the retail sale of jewelry, precious stones, and precious metals, and as illustrated in FIG. 2A, user 101 may provide, to input unit 109B, input 206 that interacts with interactive text box 202A and specifies SIC code 5944 associated with the local business operated by user 101. User 101 may also provide, to input unit 109B, input 208 that interacts with interactive text box 204A and specifies the text string that characterizes the actual business activities of the local business operated by user 101 (e.g., “My business involves buying and selling gold and raw diamonds”). Further, upon provisioning of the requested elements of compliance data (e.g., as specified by inputs 206 and 208), the application of user 101 for the business checking account, and user 101 may elect to submit the now-completed application, which includes the compliance data along with application data identifying and characterizing the business checking account, user 101, and the local business, to the financial institution for processing, and user 101 may provide input 210 to input unit 109B that selects a “SUBMIT” icon 212 within digital interface 200.

Input unit 109B may receive each of provisioned inputs 206, 208, and 210, and may route elements of input data 214 (which includes the application and compliance data) to executed mobile banking application 108. In some instances, a request generation module 216 of executed mobile banking application 108 (or of executed web browser 106) may perform operations that parse input data 214 and obtain the elements of application data (e.g., application data 218) that identify and characterize the requested business checking account, user 101, and the local business, and the elements of compliance data (e.g., compliance data 220) that characterize the industry associated with the local business operated by user 101 and the actual business activities of the local business operated by user 101 (e.g., the SIC code 5944 and the text string described herein). As illustrated in FIG. 2A, executed request generation module 216 may also package the elements of application data 218 and compliance data 220 into corresponding portions of a product request 222, along with a request identifier 224 associated with product request 222 and as such, with user 101's application for the business checking account.

Executed request generation module 216 may provide product request 222, which includes request identifier 224 and the elements of application data 218 and compliance data 220, as inputs to a routing module 226 executed by the one or more processors of client device 102, e.g., by processor 104. In some instances, executed routing module 226 may perform operations that identify a unique network address of FI computing system 130 (e.g., an assigned IP address of FI computing system 130 maintained within memory 103, etc.), and that cause client device 102 to transmit product request 222 across network 120 to FI computing system 130. Further, although not illustrated in FIG. 2A, executed mobile banking application 108 (or executed web browser 106, or an additional, or alternate, application program executed by processor 104) may perform operations that encrypt all, or a selected portion, product request 222 using a corresponding encryption key (e.g., a public cryptographic key generated by, or associated with, FI computing system 130) prior to transmission across network 120 to FI computing system 130.

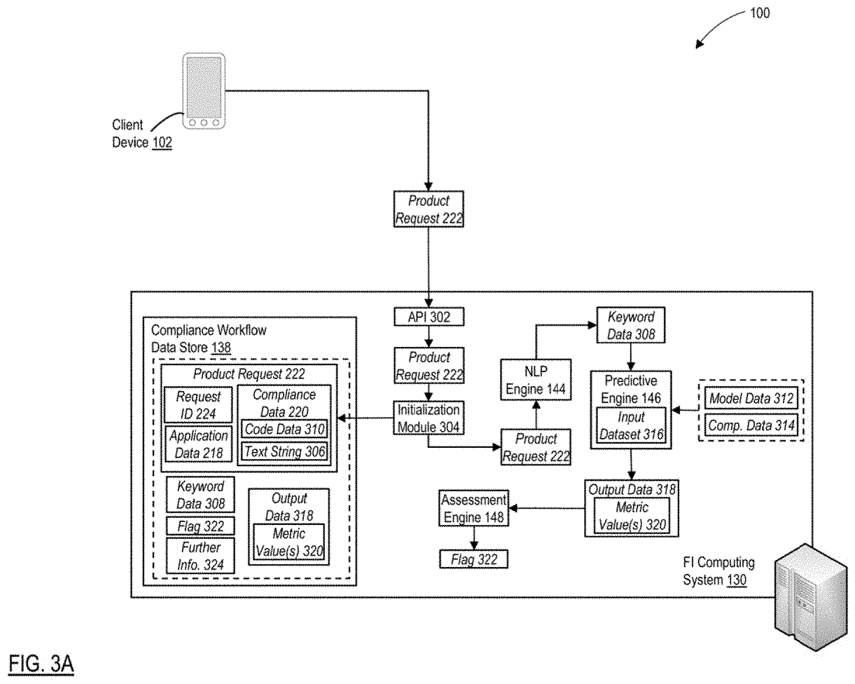

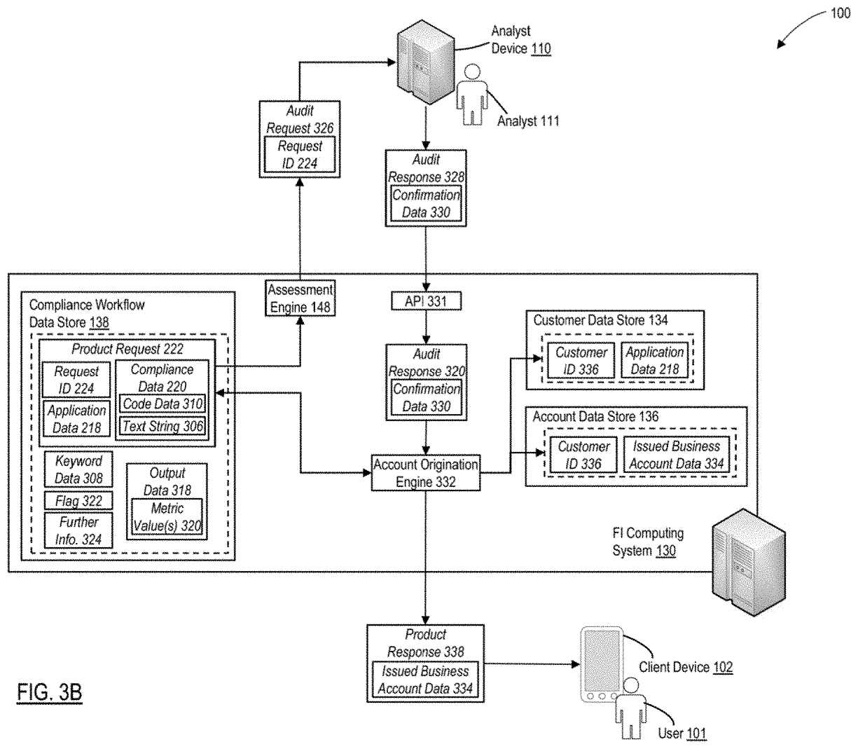

Referring to FIG. 3A, a programmatic interface established and maintained by FI computing system 130, such as application programming interface (API) 302, may receive product request 222 and may route product request 222 to an initialization module 304 executed by the one or more processors of FI computing system 130. In some instances, API 302 may be associated with or established by executed initialization module 304, and may facilitate secure, module-to-module communications across network 120 between executed initialization module 304 and client device 102 (e.g., via communications interface 109C). Executed initialization module 304 may, for example, parse product request 222 and may perform operations (not illustrated in FIG. 3A) that verify an authenticity or an integrity of product request 222. Further, one or more portions of product request 222 may be encrypted, and executed initialization module 304 may perform operations (also not illustrated in FIG. 3A) that decrypt the encrypted portions of product request 222 using a corresponding decryption key, such as a private cryptographic key associated with, or generated by, FI computing system 130. Executed initialization module 304 may, in some instances, also perform operations that store product request 222 within a corresponding portion of one or more of the tangible, non-transitory memories of FI computing system 130, e.g., within a portion of compliance workflow data store 138.

Further, in some examples, executed initialization module 304 may provide product request 222 as an input to NLP engine 144, which may be executed by the one or more processors of FI computing system 130 (e.g., in response to a programmatic command generated by executed initialization module 304, and provisioned through a corresponding programmatic interface). Executed NLP engine 144 may receive product request 222, and may perform operations that obtain, all, or a selected portion, of text string 306 from the elements of compliance data 220. As described herein, text string 306 may include one or more elements of natural language that characterize the actual business activities of the local business operated by user 101 within Washington, D.C., such as, but not limited to, the sentence “My business involves the sale of gold and raw diamonds,” as provisioned by user 101 to interactive text box 204A of digital interface 200. Executed NLP engine 144 may, for example, apply one or more of the trained NLP operations described herein to the elements of natural language maintained within text string 306, and based on the application of the trained NLP operations to the elements of natural language, NLP engine 144 may identify one or more discrete linguistic elements (e.g., words, etc.) within text string 306, and may establish a context and a semantic meaning of the discrete linguistic elements or of combinations of the discrete linguistic elements, e.g., based on the identified discrete linguistic elements, relationships between these discrete linguistic elements, and relative positions of these discrete linguistic elements within text string 306.

Based on the established content and meaning of the discrete linguistic elements, or of the combinations of the discrete linguistic elements, executed NLP engine 144 may perform operations that generate one or more keywords (or combinations of keywords) that are representative of the actual business activities of the local business operated by user 101, and that package each of the generated keywords into a corresponding portion of keyword data 308. By way of example, the one or more generated keywords (or the combinations of the keywords) may include one or more of the discrete linguistic elements within text string 306, e.g., as identified by executed NLP engine 144 using any of the exemplary processes described herein. In further examples, and based on the discrete linguistic elements and on the established context and semantic meaning of the discrete linguistic elements (and/or of the combinations of the discrete linguistic elements), executed NLP engine 144 may perform additional operations to generate one or more additional keywords that, although distinct from the generated keywords, exhibit a contextual and semantic similarity with corresponding ones of the generated keywords and are further representative of the actual business activities of the local business operated by user 101. For instance, the one or more additional keywords may include, but are not limited to, a synonym of a corresponding one of the generated keywords or an additional keyword having a contextual or semantic similarity with a corresponding one of the generated keywords, and executed NLP engine 144 may perform package the each of the generated keywords and the additional keywords, which establish collectively an “expanded” set of keywords, into corresponding portions of keyword data 308.

By way of example, and based on the application of the trained NLP algorithms or processes to the sentence “My business involves the sale of gold and raw diamonds,” executed NLP engine 144 may generate discrete linguistic elements that include, but are not limited to, “my,” “business,” “involves,” “buying,” “and,” “selling,” “gold,” “and,” “raw,” “diamonds.” Further, and based on the established context and meaning of these discrete linguistic elements, executed NLP engine 144 may perform any of the exemplary processes described herein that generate keywords (or combinations of keywords) that are representative of the actual business activities of the local business operated by user 101, and examples of the generated keywords (or combinations of keywords) may include, but are not limited to, “buying,” “selling,” “gold,” “raw,” and “diamonds.” Further, and through an implementation of any of the exemplary processes described herein, executed NLP engine 144 may also generate one or more additional keywords that, although not included within text string 306, exhibit a contextual or semantic similarity with corresponding ones of the generated keywords and are further representative of the actual business activities of the local business operated by user 101. Examples of these additional keywords may include, but are not limited to, the keyword “trading” (e.g., synonym of buying or selling), and the keywords “uncut,” “jewel,” “commodity,” and “wholesale market” (each exhibiting a contextual or semantic similarity with one or more of the generated keywords). In some instances, executed NLP engine 144 may package each of the generated keywords, and the extracted keywords, into a corresponding portion of keyword data 308.

As described herein, examples of these NLP operations may include one or more machine learning processes, such as, but not limited to, a clustering algorithm or unsupervised learning algorithm (e.g., a k-means algorithm, a mixture model, a hierarchical clustering algorithm, etc.), or a semi-supervised learning algorithm. In other examples, the one or more NLP operations may also include one or more artificial intelligence processes, such as, but not limited to, an artificial neural network model, a decision-tree algorithm a recurrent neural network model, a Bayesian network model, or a Markov model. The one or more NLP operations may also include one or more adaptive or deterministic statistical processes, such as those that make probabilistic decisions based on attaching real-valued weights to elements of certain input data. Further, in some examples, the one or more NLP operations may also include one or more text parsing algorithms or processes, such as, but not limited to, a top-down parser (e.g., a recursive descent parser, a non-recursive descent parser), a bottom-up parser (e.g., an LR parser, an operator precedence parser, etc.), or an operator precedence parsers.

Referring back to FIG. 3A, executed NLP engine 144 may perform operations that store keyword data 308 within a corresponding portion of one or more of the tangible, non-transitory memories of FI computing system 130, e.g., within a portion of compliance workflow data store 138 in conjunction with, or in association with, product request 222 (and request identifier 224). Further, executed NLP engine 144 may also provide keyword data 308 as an input to predictive engine 146, which may be executed by the one or more processors of FI computing system 130 (e.g., in response to a programmatic command generated by executed NLP engine 144 or by executed initialization module 304, and provisioned through a corresponding programmatic interface). In some instances, executed predictive engine 146 may perform any of the exemplary processes described herein to: (i) apply a trained machine learning or artificial intelligence process to an input dataset that includes the classification code assigned to, or characterizing, the industry associated with the local business operated by user 101 (e.g., SIC code 5944 provisioned to interactive text box 202A of digital interface 200 by user 101) and one or more of the keywords maintained within keyword data 308; and (ii) based on the application of the trained machine-learning and artificial-intelligence process to the input dataset, generate a value of one or metrics that, individually or collectively, indicate a predicted likelihood that user 101, or the issuance of the business checking account, represents a potential AML risk to the financial institution.

By way of example, as illustrated in FIG. 3A, executed predictive engine 146 may receive keyword data 308 from executed NLP engine 144, and may perform operations that access compliance workflow data store 138 (e.g., as maintained within the one or more tangible, non-transitory memories accessible to FI computing system 130) and obtain all, or a selected portion of, code data 310 from compliance data 220. As described herein, code data 310 may include the SIC code associated with the local business operated by user 101 (e.g., SIC code 5944), and executed predictive engine 146 may also perform operations that obtain, from the one or more tangible, non-transitory memories accessible to FI computing system 130, elements of model data 312, which specify one or more parameters of the trained machine-learning and artificial-intelligence process (e.g., a tree depth, a number of nodes, etc.), and elements of composition data 314, which specify a composition of the input dataset for the trained machine-learning and artificial-intelligence process.

In some instances, and in accordance with the elements of composition data 314, executed predictive engine 146 may perform operations that generate an input dataset 316 that includes the SIC code associated with the local business operated by user 101 (e.g., as maintained within code data 310) and all, or a selected subset of, the keywords that characterize the actual business activities of the local business operated by user 101 (e.g., as maintained within keyword data 308). For example, input dataset 316 may include SIC code 5944, along with one or more of keywords “buying,” “selling,” “gold,” “raw,” and “diamonds” extracted from text string 306 and additionally, or alternatively, one or more of expanded keywords “uncut,” “jewel,” “commodity,” and “wholesale market,” and each of SIC code 5944, the extracted keywords, or the expanded keywords may be ordered within input dataset 316 in accordance with the elements of composition data 314.

Further, and in accordance with the elements of model data 312, executed predictive engine 144 may apply the trained machine-learning or artificial-intelligence process to the elements of input dataset 316, and based on the application of the trained machine-learning or artificial-intelligence process to the elements of input dataset 316, generate one or more elements of output data 318 that characterize a predicted likelihood that user 101, or the issuance of the business checking account, represents a potential AML risk to the financial institution. By way of example, the trained machine-learning or artificial-intelligence process may include an artificial neural network that, upon implementation by executed predictive engine 146 in accordance with the elements of model data 312, includes an input layer having a plurality of input nodes that receive (e.g., “ingest”) corresponding elements of input dataset 316, an output layer that generates (e.g., “outputs”) the elements of output data 318, and one or more intermediate, computational layers disposed between the input and output layers. For instance, each of the nodes of the input layer may be established by a virtual machine instantiated by the one or more processors of FI computing system 130, and additionally, or alternatively, a corresponding one or more distributed processors or distributed computing components of FI computing system 130 (e.g., across one or more of the distributed or cloud-based computing clusters described herein).

The elements of output data 318 may, for example, include a value 320 of one or more metrics that, individually or collectively, indicate a predicted likelihood that user 101, or the issuance of the business checking account, represents a potential AML risk to the financial institution. In some instances, metric value(s) 320 may represent a numerical value ranging from zero (e.g., a minimal predicted likelihood of AML risk) to unity (e.g., a maximum predicted likelihood of AML). Further, in some instances, metric value(s) may include an additional numerical value indicative of determined level of consistency between (i) SIC code 5944 associated with the local business operated by user 101 (e.g., as maintained within code data 310) and (ii) the one or more extracted or expanded keywords characterizing the actual business activities of that local business (e.g., as maintained by within keyword data 308). As described herein, a determined inconsistency between the SIC code 5944 and the extracted or expanded keywords may be indicative of an intent, by user 101, to deceive the financial institution regarding the true nature of the business activities of the local business, and may indicate that user 101, and the issuance of the business checking account, represents a potential AML risk to the financial institution.

As illustrated in FIG. 3A, executed predictive engine 146 may perform operations that store the elements of output data 318 within a corresponding portion of one or more of the tangible, non-transitory memories of FI computing system 130, e.g., within a portion of compliance workflow data store 138 in conjunction with, or in association with, product request 222 (and request identifier 224) and keyword data 308. Further, executed predictive engine 146 may also provide the elements of output data 318, including metric value(s) 320, as an input to assessment engine 148, which may be executed by the one or more processors of FI computing system 130 (e.g., in response to a programmatic command generated by executed predictive engine 146 or by executed initialization module 304, and provisioned through a corresponding programmatic interface). In some instances, and upon execution by the one or more processors of FI computing system 130, assessment engine 148 may perform any of the exemplary processes described herein to determine, based on a comparison between the elements of output data 318 (including metric value(s) 320) and one or more compliance criteria, whether user 101, or the issuance of the business checking account, represents a potential AML risk to the financial institution, and further, whether the perform additional diligence on user 101 and/or the requested business checking account based on the potential AML risk.

As described herein, metric value(s) 320 may include a numerical value ranging from zero to unity, the one or more compliance criteria may include a corresponding threshold value, and in some instances, executed assessment engine 148 may determine whether user 101, or the issuance of the business checking account, represents a potential AML risk to the financial institution based on a comparison between the numerical value and a corresponding threshold value. By way of example, the corresponding threshold value may include a predetermined threshold value that is specific to user 101 (e.g., a customer-specific threshold value) or the requested business checking account (e.g., a product-specific threshold value, and the predetermined customer- or product-specific threshold value may be established by the FI computing system 130 based on customer-or product-specific factors that include, but are not limited to, a product type associated with the requested product (e.g., the requested business checking account), the industry associated with the local business operated by user 101 (e.g., SIC code 5944, etc.), one or more characteristics of the local business operated by user 101 (e.g., a stream of revenue, a corporate structure, a jurisdiction of incorporation, etc., as maintained within application data 218 of product request 222), and/or data characterizing a behavior of one or existing business customers of the financial institution that are similar to user 101.

In further instances, not illustrated in FIG. 1, FI computing system 130 (or executed assessment engine 148) may perform operations that determine dynamically the corresponding threshold value for user 101 in accordance with a particular temporal schedule, based on and responsive to a detected change in one or more of the characteristics of user 101, and/or based on changes in the behavior of the similar business customers of the financial institution. The disclosed embodiments are, however, not limited to the exemplary predetermined or dynamically determined threshold values, and in other instances, executed assessment engine 148 may determine whether user 101, or the issuance of the requested business checking account, represents a potential AML risk to the financial institution based on a comparison between the numerical value and any additional, or alternate, predetermined or dynamically determined threshold values that would be appropriate to user 101, the requested business checking account, or the AML regulations or policies imposed upon, or adopted by, the financial institution, including combinations of the exemplary predetermined or dynamically determined threshold values described herein,

By way of example, metric value(s) 320 of output data 318 may include a numerical value of 0.78, which indicates the predicted likelihood that user 101, or the issuance of the requested business checking account, represents a potential AML risk to the financial institution (e.g., ranging from zero to unity, with zero being indicative of a minimum predicted likelihood, and with unit being of a maximum predicted likelihood), and the corresponding threshold value for user 101, and for the business checking account, may include a numerical value of 0.7. In some examples, executed assessment engine 148 may establish that the numerical value of 0.78 exceed the corresponding threshold value of 0.7, and as such, may determine that user 101, and the issuance of the business checking account, represent an ongoing, potential AML risk to the financial institution (e.g., that the issuance of the business checking account to user 101 would be inconsistent with the current AML regulations or policies imposed on the financial institution). Based on the determination that user 101, and the issuance of the business checking account to user 101, pose a potential AML risk to the financial institution, executed assessment engine 148 may perform operations that initiate a performance of additional diligence operations involving user 101 and/or the local business operated by user 101 prior to an approval of the application of user 101 for the business checking account and any issuance of the business checking account to user 101. For example, a performance of these additional diligence operations by FI computing system 130, either alone or in conjunction with additional computing systems or devices within environment 100, such as analyst device 112, may confirm whether user 101, or the issuance of the business checking account to user 101, poses an actual AML risk to the financial institution.

In some instances, these additional diligence operations may, for example, include obtaining further information characterizing user 101 or the local business from client device 102 (e.g., based on input provisioned by user 101 in response to a presentation of additional interface elements within digital interface 200) or from data repositories maintained by one or more additional computing systems operating with environment 100 (e.g., based on a programmatic channel of communications established between FI computing system 130 and one or more application programs executed by the additional computing systems). By way of example, the one or more additional computing systems may be associated with, or operated by, a corresponding governmental, regulatory, judicial, or reporting entity (e.g., a credit bureau or other reporting agency), and the further information obtained from the data repositories maintained by these additional computing systems may include, but is not limited, a credit report associated with user 101 or the local business, information identifying a presence, or absence, of outstanding tax obligations involving user 101 or the local business, or information identifying a presence, or absence, of outstanding legal matters or outstanding judgements involving, or naming, user 101 or the local business. The disclosed embodiments are, however, not limited to these examples of further information, and in other instances, the further information may include any additional, or alternate, elements of information that facilitate a determination, by FI computing system 130, of a compliance, or non-compliance, of user 101's application for the business checking account with the current AML regulations or policies imposed on the financial institution.

By way of example, and based on the determination that user 101, and the issuance of the business checking account to user 101, pose a potential AML risk to the financial institution, executed assessment engine 148 may generate elements of data (e.g., non-compliance flag 322 of FIG. 3A) that flag the application of user 101 for the business checking account for a performance of the additional diligence operations described herein. Executed assessment engine 148 may also perform operations that store non-compliance flag 322 within a corresponding portion of one or more of the tangible, non-transitory memories of FI computing system 130, e.g., within a portion of compliance workflow data store 138 in conjunction with, or in association with, product request 222 (and request identifier 224), keyword data 308, and the elements of output data 318.

In some instances, and based on the detection of non-compliance flag 322, FI computing system 130 may perform operations (not illustrated in FIG. 3A) that: (i) transmit data requesting portions of the further information characterizing user 101 or the local business across network 120 to client device 102, which may present, within digital interface 200, the additional interface elements that prompt user 101 to provide input to client device 102 specifying the portions of the further information; and/or (ii) establish the programmatic channel of communications with the one or more additional computing systems, and request, and receive, portions of the further information characterizing user 101 or the local business from the data repositories maintained by the one or more additional computing systems, e.g., across the programmatic channels of communications via corresponding programmatic interfaces. Although not illustrated in FIG. 3A, FI computing system 130 may store the portions of further information characterizing user 101 or the local business (e.g., as obtained from client device 102 or from the additional computing systems) within a corresponding portion of one or more of the tangible, non-transitory memories of FI computing system 130, e.g., as further information 324 within a portion of compliance workflow data store 138 in conjunction with, or in association with, product request 222 (and request identifier 224), keyword data 308, the elements of output data 318, and non-compliance flag 322.

The disclosed embodiments are, however, not limited to processes through which FI computing system 130 obtains programmatically portions of further information 324 from client device 102 and/or the data repositories of the one or more additional computing systems operating within environment 100. In other examples, a computing system or device operable by a representative of the financial institution, such as, but not limited to, analyst device 112 operable by analyst 111, may perform operations (not illustrated in FIG. 3A) that obtain additional portions of further information 324 from the data repositories of the one or more additional computing systems, and that route additional portions of further information 324 across network 120 to FI computing system 130, e.g., for storage within compliance workflow data store 138. For instance, analyst device 10 may execute an application program, such as a web browser, that causes analyst device 112 to access a web page associated with the data repository maintained by a corresponding one of the additional computing systems. Based on input provided to analyst device 112 by analyst 111 (e.g., via the corresponding input unit), the executed web browser may enable analyst 111 to interact with, and query, elements of data maintained within the data repository, and to request and receive the additional portions of further information 324 maintained within the data repository (e.g., based on messages, structured in hypertext transfer protocol (HTTP) or hypertext transfer protocol secure (HTTPS), exchanged between the executed web browser and an application front-end of an application program executed by the corresponding one of the additional computing systems).

Referring to FIG. 3B, and based on further information 324 characterizing user 101 or the local business, analyst 111 may determine whether the portions of further information 324 establish a compliance of user 101, and the application by user 101 for the requested business checking account, with the current AML regulations or policies imposed on the financial institution. For, executed assessment engine 148 may perform operations that access compliance workflow data store 138 (e.g., as maintained within the one or more tangible, non-transitory memories accessible to FI computing system 130), and obtain request identifier 224 from product request 222. As described herein, request identifier 224 may be associated with an application, by user 101, for the business checking account issued by the financial institution, and compliance workflow data store 138 may maintain request identifier 224 (and as such, product request 222) in conjunction with, and in association with, keyword data 308, the elements of output data 318, non-compliance flag 322, and further information 324. In some instances, executed assessment engine 148 may package request identifier 224 into a corresponding portion of an audit request 326, which FI computing system 130 may transmit across network 120 to analyst device 112.

Analyst device 112 may receive audit request 326, and may store audit request within a corresponding portion of a tangible, non-transitory memory (not illustrated in FIG. 3B). Further, although not illustrated in FIG. 3B, the one or more processors of analyst device may execute an application program, such as a web browser or an application program provisioned by FI computing system 130, which may perform operations that, based on request identifier 224, access compliance workflow data store 138 of FI computing system 130, obtain application data 218 and compliance data 220 of product request 222, and obtain further information 324 that characterize user 101 and the local business. The executed application program may cause analyst device 112 to present, within a corresponding digital interface (e.g., via a corresponding display unit, such as those described herein), portions of application data 218, compliance data 220, and further information 324 within one or more display screens.

In some instances, also not illustrated in FIG. 3B, a representative of the financial institution, such as analyst 111, may view and interact with the portions of application data 218, compliance data 220, and further information 324 presented within the one or more display screens of the corresponding digital interface, and may provide input (e.g., via a corresponding input unit, such as those described herein) indicative of a determination, by analyst 111, that the further information establishes a compliance, or a continued non-compliance, of user 101, and the application by user 101 for the business checking account, with the current AML regulations or policies imposed on the financial institution, and as such, whether user 101, and the application by user 101 for the business checking account, poses an actual AML risk to the financial institution. Based on the provisioned input, analyst device 112 may perform operations that generate elements of an audit response 328, which include request identifier 224 and data 330 confirming the determined compliance, or the determined, continued non-compliance, of user 101, and the application by user 101 for the business checking account, with the current AML regulations or policies imposed on the financial institution.

As illustrated in FIG. 3B, analyst device 112 may transmit audit response 328 across network 120 to FI computing system 130, and a programmatic interface established and maintained by FI computing system 130, such as, but not limited to an application programming interface (API) 331, may receive and route audit response 328 to an account origination engine 332 executed by the one or more processors of FI computing system 130. In some instances, executed account origination engine 332 may receive audit response 328, and based on confirmation data 330 maintained within audit response 328, executed account origination engine 332 may establish whether analyst 111 deemed user 101, and the application by user 101 for the requested business checking account, compliant or non-compliant with the current AML regulations or policies imposed on the financial institution (e.g., based on the portions of FI computing system 30, etc.). If, for example, executed account origination engine 332 were to establish that analyst 111 deemed user 101, and the application by user 101 for the business checking account, compliant with the currently imposed AML regulations or policies, executed account origination engine 332 may establish that neither user 101, nor the application by user 101 for the business checking account, represent an actual AML risk to the financial institution, and executed account origination engine 332 may perform any of the exemplary processes described to determine whether to approve user 101's application for the business checking account, and to determine whether open and issue the business checking account to user 101.

For example, executed account origination engine 332 may obtain request identifier 224 from audit response 328, and may perform operations that access compliance workflow data store 138 and obtain product request 222 that includes, among other things, request identifier 224 and application data 218. In some instances, and based on an application of one or more internal origination criteria to elements of application data 218 obtained from product request 222 (e.g., that identify and characterize user 101, the local business operated by user 101, or the requested business checking account), executed account origination engine 332 may determine one or more terms and conditions application to the requested business checking account, and may perform operations that open and issue the business checking account to user 101 in accordance with the determined terms and conditions. As illustrated in FIG. 3B, executed account origination engine 332 may generate one or more elements of issued business account data 334, which identify the newly issued business checking account (e.g., a tokenized account number, a bank routing number, etc.) and the determined terms and conditions of that newly-issued business checking account, and may generate and assign a unique customer identifier 336 to user 101, which may include, but is not limited to, an alphanumeric authentication credential, a portion of a customer name of user 101, or a biometric credential associated with user 101.

As illustrated in FIG. 3B, executed account origination engine 332 may perform operations that store customer identifier 336 and portions of application data 218 within the one or more tangible, non-transitory memories accessible to FI computing system 130, e.g., within the data records of customer data store 134 of data repository 132. Executed account origination engine 332 may also perform operations that store customer identifier 336 and issued business account data 334 within an additional portion of the one or more tangible, non-transitory memories accessible to FI computing system 130, e.g., within the data records of account data store 136 of data repository 132. In some instances, executed account origination engine 332 may also package all, or a selected portion of issued business account data 334 into corresponding portions of a product response 338, which FI computing system 130 may transmit across network 120 to client device 102. Further, although not illustrated in FIG. 3B, executed account origination engine 332 may perform operations that encrypt product response 338 using a corresponding encryption key (e.g., a public cryptographic key of client device 102 or executed mobile banking application 108) prior to transmission across network 120 to client device 102.

In some instances, also not illustrated in FIG. 3B, a programmatic interface established and maintained by client device 102 may receive product response 338, and may route product response 338 to executed mobile banking application 108 (or executed web browser 106, etc.). Executed mobile banking application 108 (or executed web browser 106, etc.) may decrypt the encrypted portions of product response 338 using a corresponding decryption key (e.g., a private cryptographic key of client device 102 or executed mobile banking application 108 or executed web browser 106, etc.), and may perform any of the exemplary processes described herein to generate one or more interface elements based on product response 338 that, upon presentation within digital interface 200, confirm the issuance of the business checking account requested by user 101 and identify the determined terms and conditions of the issued business checking account (also not illustrated in FIG. 3B).

In other instances, executed account origination engine 332 may perform additional operations that decline to issue the business checking account to user 101 based on the application of the one or more internal origination criteria to the elements of application data 218, or alternatively, that establish analyst 111 deemed user 101, and user 101's application for the business checking account, non-compliant with the current AML regulations or policies imposed on the financial institution and as such, an actual AML risk to the financial institution. For example, executed account origination engine 332 may generate an additional product response confirming the decision to decline the issuance of the requested business checking account to user 101, or confirming the established non-compliance of user 101, and user 101's application for the business checking account, with the currently imposed AML regulations, and executed account origination engine 332 may perform operations (not illustrated in FIG. 3B) that cause FI computing system to transmit the additional product response across network 120 to client device 102, e.g., for presentation within digital interface 200 using any of the exemplary processes described herein.

As described herein, executed assessment engine 148 of FI computing system 130 may establish that one or more of metric value(s) 320 of output data 318 are inconsistent with the predetermined or dynamically determined threshold value described herein and as such, may determine that user 101, and the issuance of the requested business checking account, represent an ongoing, potential AML risk to the financial institution. In other examples, not illustrated in FIG. 3A or 3B, executed assessment engine 148 of FI computing system 130 may establish that each of metric value(s) 320 is consistent with the predetermined or dynamically determined threshold value (e.g., that the predetermined or dynamically determined threshold value exceed a corresponding numerical value included within metric value(s) 320). Based on the established consistency, executed assessment engine 148 may generate an additional element of data, such as a compliance flag, confirming the determination that user 101, and the issuance of the business checking account, are compliant with the current AML regulations or policies imposed on the financial institution.

In some instances, not illustrated in FIG. 3A or 3B, executed assessment engine 148 may perform any of the exemplary processes described herein to store the compliance flag within a portion of compliance workflow data store 138 (e.g., in conjunction with, or in association with, product request 222 (and request identifier 224), keyword data 308, and the elements of output data 318). Further, although not illustrated in FIG. 3A or 3B, executed assessment engine 148 may also provide the compliance flag as an input to executed account origination module 332, which may perform any of the exemplary processes described herein to issue (or decline to issue) the business checking account to user 101 based on the application of the one or more internal origination criteria to the elements of application data 218, to generate and transmit an additional product response associated with the issued business checking account, or the decision to decline to issue to business checking account to user 101.

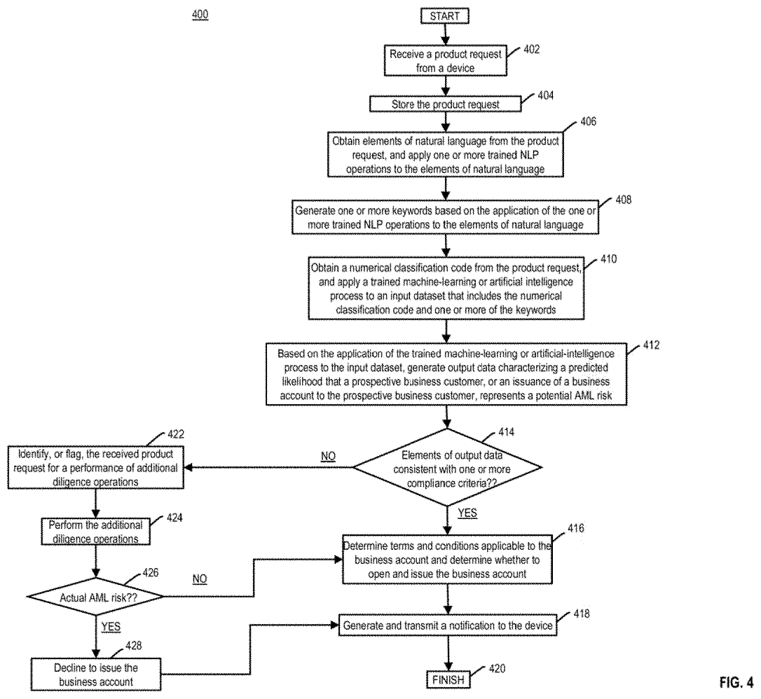

FIG. 4 is a flowchart of an exemplary process 400 for dynamically managing compliance workflow using trained machine-learning or artificial-intelligence processes. In some examples, and as described herein, a network-connected computing system associated with, or operable by a financial institution, such as, but not limited to, FI computing system 130, may perform one or more of the steps of exemplary process 400, which include, among other things, receiving a product request from a device (e.g., client device 102 of FIG. 1) operable by a prospective business customer of the financial institution (e.g., user 101 of FIG. 1). As described herein, user 101 may operate a corresponding business, such as, but not limited to, the local business in Washington, D.C., that trades in raw diamonds and gold, and the product request may identify and characterize a request, by user 101, to access one or more financial products or services offered by a financial institution, such as, but not limited to, a business account offered by the financial institution (e.g., a business checking account, etc.).

For example, the product request may include one or more elements of application data e.g., application data 218 of FIG. 2A), which identify and characterize the business account, user 101, and the corresponding business, and one or more elements of compliance data (e.g., compliance data 220 of FIG. 2A) that characterize the industry associated with the corresponding business and the actual business activities of the corresponding business (e.g., a numerical classification code and a text string including elements of natural language, as described herein). As described herein, FI computing system 130 perform additional steps of exemplary process 400, which include, among other things, generating one or more keywords that are representative of the actual business activities of the corresponding business based on an application of a trained, natural language processing (NLP) operation to the elements of natural language within the text string, and based on an application of a trained machine-learning or artificial-intelligence process to the numerical classification code and at least a subset of the keywords, generate elements of output data that characterize a predicted likelihood that user 101, or an issuance of the business account to user 101, represent a potential anti-money laundering (AML) risk to the financial institution. Further, and based on the elements of output data, FI computing system may perform additional steps of exemplary process 300 to determine a compliance, or non-compliance, of user 101, and the issuance of the business account to user 101, with one or more AML regulations or policies imposed on the financial institution, and based on a determined non-compliance, to identify the received product request (e.g., to “flag” the received product request) for a performance of additional diligence operations prior to the issuance of the requested business product to user 101.

Referring to FIG. 4, FI computing system 130 may receive, from client device 102, a product request that identifies and characterizes an application, of user 101, for a financial product or service offered by the financial institution (e.g., in step 402 of FIG. 4). As described herein, user 101 may correspond to a prospective business customer of the financial institution that operates a corresponding business, and the financial product or service may include a business account offered to business customers by the financial institution, such as, but not limited to, a business checking account, a business credit card account, or a business-specific line-of-credit. Further, and as described herein, the received product request may include, among other things, an alphanumeric request identifier assigned to the product request by an application program executed by client device 102 (e.g., web browser 106, mobile banking application 108, etc.), one or more elements of application data associated with, and one or more elements of compliance data.

By way of example, the elements of application data may identify and characterize the business account associated with the application (e.g., a product type of the business checking account, etc.), identify and characterize user 101 (e.g., a full name and street address of user 101, a date of birth of user 101, and/or a governmental identifier assigned to user 101, such as a driver's license number or a social security number, etc.), and additionally, or alternatively, identify and characterize the corresponding business (e.g., a full name and business address, an identifier assigned to the local business by a governmental entity, such as an employer identification number (EIN), or a state of incorporation, etc.). Further, in some examples, the elements of compliance data may include, among other things, a numerical classification code that characterizes the industry associated with the corresponding business (e.g., a four-digit SIC code, a four-digit MCC, etc.,) and elements of natural language (e.g., a textual string that includes a sentence, a phrase, etc.) that characterize the actual business activities of the corresponding business. Further, and as described herein, user 101 may provision all, or a portion of, the application data and the compliance data to client device 102 (e.g., via input unit 109B) in response to a presentation of one or more interface elements within a corresponding digital interface (e.g., within digital interface 200 of FIG. 2).

In some instances, FI computing system 130 may perform operations that store the received product request within one or more tangible, non-transitory memories accessible FI computing system (e.g., in step 404 of FIG. 4). Further, and as illustrated in FIG. 4, FI computing system 130 may perform any of the exemplary processes described herein to obtain, from the received product request, the elements of natural language that characterize the actual business activities of the corresponding business (e.g., the text string included within the compliance data), and to apply one or more trained NLP operations to each, or selected subset, of the elements of natural language (e.g., in step 406 of FIG. 4). Further, and based on the application of the one or more trained NLP operations to the elements of natural language, FI computing system 130 may perform any of the exemplary processes described herein to generate one or more keywords (or combinations of keywords) that are representative of the actual business activities of the corresponding business (e.g., in step 408 of FIG. 4).

In some instances, and based on the application of the trained NLP algorithms or processes to the elements of natural language, FI computing system 130 may perform, in step 408, any of the exemplary processes described herein to identify one or more discrete linguistic elements (e.g., a word, etc.) within the text string, and to establish a context and a semantic meaning of the discrete linguistic elements or of combinations of the discrete linguistic elements, e.g., based on the identified discrete linguistic elements, relationships between these discrete linguistic elements, and relative positions of these discrete linguistic elements within the text string. Further, FI computing system 130 may also perform any of the exemplary processes described herein to generate the one or more keywords (or the combinations of keywords) based on the established content and semantic meaning of the discrete linguistic elements, or of the combinations of the discrete linguistic elements, and to store the generated keywords within the corresponding portion of the one or more tangible memories (e.g., also in step 408 of FIG. 4).

By way of example, the generated keywords (or the combinations of the keywords) may include one or more of the discrete linguistic elements included within the text string maintained within the compliance data of the received product request. In further examples, and based on the discrete linguistic elements and on the established context and semantic meaning of the discrete linguistic elements (and/or of the combinations of the discrete linguistic elements), FI computing system 130 may perform any of the exemplary processes described herein to generate one or more additional keywords that, although distinct from the generated keywords, exhibit a contextual or semantic similarity with corresponding ones of the generated keywords and are further representative of the actual business activities of the corresponding business (e.g., also in step 408 of FIG. 4). The one or more additional keywords may include, but are not limited to, a synonym of a corresponding one of the generated keywords or an additional keyword having a contextual similarity with a corresponding one of the generated keywords, and FI computing system 130 may perform operations that store the generated keywords and the additional keywords, which may establish collectively an “expanded” set of keywords, within the corresponding portion of the one or more tangible, non-transitory memories (e.g., also in step 408 of FIG. 4).

As described herein, examples of these trained NLP operations may include one or more machine learning processes, such as, but not limited to, a clustering algorithm or unsupervised learning algorithm (e.g., a k-means algorithm, a mixture model, a hierarchical clustering algorithm, etc.), or a semi-supervised learning algorithm. In other examples, the one or more trained NLP operations may also include one or more artificial intelligence processes, such as, but not limited to, an artificial neural network model, a decision-tree algorithm a recurrent neural network model, a Bayesian network model, or a Markov model. The one or more trained NLP operations may also include one or more adaptive or deterministic statistical processes, such as those that make probabilistic decisions based on attaching real-valued weights to elements of certain input data. Further, in some examples, the one or more trained NLP operations may also include one or more text parsing algorithms or processes, such as, but not limited to, a top-down parser (e.g., a recursive descent parser, a non-recursive descent parser), a bottom-up parser (e.g., an LR parser, an operator precedence parser, etc.), or an operator precedence parsers.

Referring back to FIG. 4, FI computing system 130 may perform any of the exemplary processes described herein to obtain, from the received product request, the numerical classification code assigned to, or characterizing, the industry associated with the business operated by user 101 (e.g., the four-digit SIC code or MCC maintained within the compliance data of the received product request), to apply a trained machine-learning or artificial-intelligence process to an input dataset that includes the numerical classification code and at least a subset of the keywords representative of the actual business activities of the corresponding business (e.g., in step 410 of FIG. 4). By way of example, in step 410, FI computing system 130 may perform any of the exemplary processes described herein to obtain, from the one or more tangible, non-transitory memories accessible, elements of model data, which specify one or more parameters of the trained machine-learning and artificial-intelligence process (e.g., a tree depth, a number of nodes, etc.), and elements of composition data, which specify a composition of the input dataset for the trained machine-learning and artificial-intelligence process.

FI computing system 130 may also perform operations that, in accordance with the elements of composition data, generate the input dataset based on the numerical classification code and all, or a selected subset of, the keywords that characterize the actual business activities of the corresponding business (e.g., also in step 410 of FIG. 4). As described herein, the numerical classification code and each of the keywords may be ordered within the input dataset in accordance with the elements of the composition data. Further, and in accordance with the elements of model data, FI computing system 130 may perform any of the exemplary processes described herein to apply the trained machine-learning or artificial-intelligence process to the elements of the input dataset (e.g., also in step 410 of FIG. 4).

Based on the application of the trained machine-learning or artificial-intelligence process to the elements of the input dataset, FI computing system 130 may perform any of the exemplary processes described herein to generate one or more elements of output data that characterize a predicted likelihood that user 101, or the issuance of the business account, represents a potential AML risk to the financial institution (e.g., in step 412 of FIG. 4). Further, FI computing system 130 may also the elements of output data within the corresponding portion of the one or more tangible, non-transitory memories in conjunction with the received product request and in instances, the generated or additional keywords (e.g., also in step 412 of FIG. 4).

The elements of output data may, for example, include a value of one or more metrics that, individually or collectively, indicate a predicted likelihood that user 101, or the issuance of the requested business account, represents a potential AML risk to the financial institution. In some instances, the metric value(s) may represent a numerical value ranging from zero (e.g., a minimal predicted likelihood of AML risk) to unity (e.g., a maximum predicted likelihood of AML). Further, in some instances, metric value(s) may include an additional numerical value indicative of determined level of consistency between (i) the numerical classification code associated with the corresponding business and (ii) the one or more keywords characterizing the actual business activities of the corresponding business. As described herein, a determined inconsistency between the numerical classification code and the one or more keywords may be indicative of an intent, by user 101, to deceive the financial institution regarding the true nature of the business activities of the corresponding business, and may indicate that user 101, and the issuance of the business checking account, poses a potential (or actual) AML risk to the financial institution.

FI computing system 130 may also perform any of the exemplary processes described herein to determine whether the elements of output data are consistent with one or more compliance criteria associated with the AML risk posed to the financial institution by user 101 or the issuance of the business account to user 101 (e.g., in step 414 of FIG. 4). By way of example, and as described herein, the elements output data may include one or more metric values that, individually or collectively, indicate a predicted likelihood that user 101, or the issuance of the requested business account, represents a potential AML risk to the financial institution. In some instances, the metric value(s) may represent a numerical value ranging from zero (e.g., a minimal predicted likelihood of AML risk) to unity (e.g., a maximum predicted likelihood of AML), and as described herein, the one or more compliance criteria may include a corresponding threshold value.

In some instances, in step 414 of FIG. 4, FI computing system 130 may determine whether the elements of output data are consistent with one or more threshold criteria based on a comparison between (i) the numerical value representative of the predicted likelihood that user 101, or the issuance of the business account, represents a potential AML risk to the financial institution and (ii) the corresponding threshold value. If FI computing system 130 were to determine that the elements of output data are consistent with the one or more threshold criteria (step 414; YES), FI computing system 130 may establish that neither user 101, nor the issuance of the business account to user 101, represents a potential AML risk to the financial institution, and that the issuance of the business account to user 101 complies with the AML regulations and policies imposed on the financial institution. By way of example, FI computing system may determine that the elements of output data are consistent with the one or more threshold criteria based on a determination that the numerical value representative of the predicted likelihood that user 101, or the issuance of the business account, represents a potential AML risk to the financial institution fails to exceeds the corresponding threshold value, which includes, but is not limited to, the predetermined or dynamically determined threshold value described herein.

In some instances, FI computing system 130 may access the elements of application data maintained within the received product request, and based on an application of one or more internal origination criteria to elements of application data, FI computing system 130 may perform any of the exemplary processes described herein to determine one or more terms and conditions applicable to the business checking account and open and issue the business checking account to user 101 in accordance with the determined terms and conditions, or alternatively, to decline to open or issue the business account to user 101 (e.g., in step 416 of FIG. 4). Further, FI computing system 130 may also perform any of the exemplary processes described herein to generate a notification that confirms the opening and issuance of the business account to user 101 and the corresponding terms and conditions, or alternatively, that confirms the decision to decline to open or issue the business account to user 101 (e.g., in step 418 of FIG. 4). FI computing system 130 may also transmit the generated notification cross network 120 to client device 102 (e.g., in step 418 of FIG. 4), and client device 102 may perform any of the exemplary processes described herein to present a graphical representation of portions of the transmitted notification within a corresponding digital interface, e.g., within digital interface 200. Exemplary process 400 is then complete in step 420.

Referring back to step 414, if FI computing system 130 were to determine that the elements of output data are inconsistent with the one or more threshold criteria (e.g., step 414; NO), may establish that user 101, or the issuance of the business account to user 101, represents a potential AML risk to the financial institution. By way of example, FI computing system 130 may determine that the elements of output data are inconsistent with the one or more threshold criteria, and that user 101 or the issuance of the business account to user 101 represents a potential AML risk to the financial institution based on a determination that the numerical value representative of the potential AML risk exceeds the corresponding, predetermined or dynamically determined threshold value.

In some instances, based on the determination that user 101 or the issuance of the business account to user 101 represents a potential AML risk to the financial institution, FI computing system 130 may perform any of the exemplary processes to identify, or flag, the received product request for a performance of additional diligence operations to establish a compliance of user 101, or the issuance of the business account to user 101, with the AML regulations or policies imposed on the financial institution (e.g., in step 422 of FIG. 4). Further, FI computing system 130 may initiate the performance of these additional diligence operations using any of the exemplary programmatic or manual processes described herein (e.g., in step 424 of FIG. 4), and based on the performance of these additional diligence operations, FI computing system 130 may perform any of the exemplary processes described herein, either individually or in conjunction with other computing devices or systems operating within environment 100 (such as analyst device 112 operable by analyst 111, etc.) to establish whether user 101, or the issuance of the business product to user 101, represent an actual AML risk to the financial institution (e.g., in step 426 of FIG. 4).

If, for example, FI computing system 130 were to confirm that, based on the performance of the additional diligence operations, user 101 or the issuance of the business account to user 101 fail to pose any actual AML threat to the financial institution (e.g., step 426; NO), exemplary process 400 may pass back to step 416, and FI computing system 130 may perform any of the exemplary processes described herein to determine one or more terms and conditions applicable to the business account and to open and issue the business account to user 101 in accordance with the determined terms and conditions, or alternatively, to decline to open or issue the business account to user 101. Alternatively, if FI computing system 130 were to determine that the performance of the additional diligence operations confirm that user 101, or the issuance of the business account to user 101, pose an actual AML threat to the financial institution (e.g., step 426; YES), FI computing system 130 perform operations, described herein, that decline to issue the business account to user 101 (e.g., in step 428 of FIG. 4). Exemplary process 400 may pass back to step 420, and FI computing system 130 may also perform any of the exemplary processes described herein to generate, and transmit across network 120 to client device 102, a notification that confirms the decision to decline to issue the business account to user 101.

### III. Exemplary Hardware and Software Implementations

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification, including web browser 106, mobile banking application 108, natural language processing (NLP) engine 144, predictive engine 146, assessment engine 148, request generation module 216, routing module 226, application programming interfaces (APIs) 302 and 331, initialization module 304, and account origination engine 332, can be implemented as one or more computer programs, i.e., one or more modules of computer program instructions encoded on a tangible non transitory program carrier for execution by, or to control the operation of, a data processing apparatus (or a computer system).

Additionally, or alternatively, the program instructions can be encoded on an artificially generated propagated signal, such as a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The terms “apparatus,” “device,” and “system” refer to data processing hardware and encompass all kinds of apparatus, devices, and machines for processing data, including by way of example a programmable processor, a computer, or multiple processors or computers. The apparatus, device, or system can also be or further include special purpose logic circuitry, such as an FPGA (field programmable gate array) or an ASIC (application-specific integrated circuit). The apparatus, device, or system can optionally include, in addition to hardware, code that creates an execution environment for computer programs, such as code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, such as one or more scripts stored in a markup language document, in a single file dedicated to the program in question, or in multiple coordinated files, such as files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, such as an FPGA (field programmable gate array) or an ASIC (application-specific integrated circuit).

Computers suitable for the execution of a computer program include, by way of example, general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, such as magnetic, magneto-optical disks, or optical disks. However, a computer need not have such devices. Moreover, a computer can be embedded in another device, such as a mobile telephone, a personal digital assistant (PDA), a mobile audio or video player, a game console, a Global Positioning System (GPS) receiver, or a portable storage device, such as a universal serial bus (USB) flash drive, to name just a few.

Computer-readable media suitable for storing computer program instructions and data include all forms of non-volatile memory, media and memory devices, including by way of example semiconductor memory devices, such as EPROM, EEPROM, and flash memory devices; magnetic disks, such as internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display unit, such as a CRT (cathode ray tube) or LCD (liquid crystal display) monitor, for displaying information to the user and a keyboard and a pointing device, such as a mouse or a trackball, by which the user can provide input to the computer. Other kinds of devices can be used to provide for interaction with a user as well; for example, feedback provided to the user can be any form of sensory feedback, such as visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Implementations of the subject matter described in this specification can be implemented in a computing system that includes a back-end component, such as a data server, or that includes a middleware component, such as an application server, or that includes a front-end component, such as a computer having a graphical user interface or a Web browser through which a user can interact with an implementation of the subject matter described in this specification, or any combination of one or more such back-end, middleware, or front-end components. The components of the system can be interconnected by any form or medium of digital data communication, such as a communication network. Examples of communication networks include a local area network (LAN) and a wide area network (WAN), such as the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, such as an HTML page, to a user device, such as for purposes of displaying data to and receiving user input from a user interacting with the user device, which acts as a client. Data generated at the user device, such as a result of the user interaction, can be received from the user device at the server.

While this specification includes many specifics, these should not be construed as limitations on the scope of the invention or of what may be claimed, but rather as descriptions of features specific to particular embodiments of the invention. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Various embodiments have been described herein with reference to the accompanying drawings. It will, however, be evident that various modifications and changes may be made thereto, and additional embodiments may be implemented, without departing from the broader scope of the disclosed embodiments as set forth in the claims that follow.

Further, other embodiments will be apparent to those skilled in the art from consideration of the specification and practice of one or more embodiments of the present disclosure. It is intended, therefore, that this disclosure and the examples herein be considered as exemplary only, with a true scope and spirit of the disclosed embodiments being indicated by the following listing of exemplary claims.

What is claimed is:

1. An apparatus, comprising:
a memory storing instructions;
a communications interface; and
at least one processor coupled to the memory and the communications interface, the at least one processor being configured to execute the instructions to:
receive request data from a device via the communications interface, the request data comprising application data associated with a product and compliance data characterizing an activity, and the compliance data comprising a classification code and textual content;
based on an application of a first trained machine-learning or artificial-intelligence process to the classification code and to at least a portion of the textual content, generate output data characterizing a predicted likelihood that the activity complies with a restriction associated with the product; and
when the output data is inconsistent with at least one compliance criterion, determine a compliance of the activity with the restriction based on additional data associated with the activity, and based on the determined compliance, perform operations that provision the product in accordance with at least a portion of the application data.

2. The apparatus of claim 1, wherein:
the textual content comprises one or more elements of natural language that characterize the activity; and
the at least one processor is further configured to:
apply a second trained machine-learning or artificial intelligence process to the elements of natural language; and
based on the application of the second trained machine-learning or artificial intelligence process to the elements of natural language, generate one or more keywords associated with the activity.

3. The apparatus of claim 2, wherein the elements of natural language comprise a plurality of discrete linguistic elements, and the discrete linguistic elements include at least one of the keywords.

4. The apparatus of claim 2, wherein the at least one processor is further configured to execute the instructions to:
obtain process data and composition data associated with the first trained machine-learning or artificial-intelligence process;
based on the composition data, generate an input dataset comprising the classification code and at least a subset of the keywords; and
apply the first trained machine-learning or artificial-intelligence process to the input dataset in accordance with the process data.

5. The apparatus of claim 1, wherein the at least one processor is further configured to execute the instructions to:
store the request data within a corresponding portion of the memory, the request data further comprising a request identifier;
determine that the output data is inconsistent with the at least one compliance criterion; and
based on the determination that the output data is inconsistent with the at least one compliance criterion, generate a data flag indicative of the inconsistency between the output data and the at least one compliance criterion, and store the data flag within the corresponding portion of the memory.

6. The apparatus of claim 5, wherein the at least one processor is further configured to executed the instructions to:
based on the determination that the output data is inconsistent with the at least one compliance criterion, perform operations that request and receive, via the communications interface, one or more elements of the additional data from a computing system; and
store the one or more elements of the additional data within the corresponding portion of the memory.

7. The apparatus of claim 6, wherein the at least one processor is further configured to execute the instructions to:
transmit, via the communications interface, an audit request that includes the request identifier and the data flag to an additional device, the additional device being configured to access the additional data based on at least the request identifier and to present a portion of the additional data within a digital interface;
receive an audit response from the additional device via the communications interface; and
determine the compliance of the activity with the restriction based on at least the audit response.

8. The apparatus of claim 1, wherein the at least one processor is further configured to transmit, via the communications interface, a notification indicative of the provisioned product to the device, the device being configured to present at least a portion of the notification within a digital interface.

9. The apparatus of claim 1, wherein:
the output data comprises a numerical value indicative of the predicted likelihood that the activity complies with the restriction;
the compliance criterion comprises a threshold value; and
the at least one processor is further configured to execute the instructions to:
determine that the numerical value exceeds the threshold value; and
determine that the output data is inconsistent with the at least one compliance criterion based on the determination that the numerical value exceeds the threshold value.

10. The apparatus of claim 1, wherein the at least one processor is further configured to execute the instructions to:
determine that the output data is consistent with the at least one compliance criterion; and
based on the determination that the output data is consistent with the at least one compliance criterion, determine that the activity complies with the restriction.

11. The apparatus of claim 1, wherein:
the device is operable by a business customer;
the activity comprises a business activity associated with the business customer;
the product comprises a business account; and
the restriction comprises a governmental or regulatory restriction associated with the business account.

12. A computer-implemented method, comprising:
receiving request data from a device using at least one processor, the request data comprising application data associated with a product and compliance data characterizing an activity, and the compliance data comprising a classification code and textual content;
based on an application of a first trained machine-learning or artificial-intelligence process to the classification code and to at least a portion of the textual content, generating, using the at least one processor, output data characterizing a predicted likelihood that the activity complies with a restriction associated with the product; and
when the output data is inconsistent with at least one compliance criterion, determining, using the at least one processor, a compliance of the activity with the restriction based on additional data associated with the activity, and based on the determined compliance, performing operations, using the at least one processor, that provision the product in accordance with at least a portion of the application data.

13. The computer-implemented method of claim 12, wherein:
the textual content comprises one or more elements of natural language that characterize the activity; and
the computer-implemented method further comprises:
using the at least one processor, applying a second trained machine-learning or artificial intelligence process to the elements of natural language; and
based on the application of the second trained machine-learning or artificial intelligence process to the elements of natural language, generating, using the at least one processor, one or more keywords associated with the activity.

14. The computer-implemented method of claim 13, wherein the elements of natural language comprise a plurality of discrete linguistic elements, and the discrete linguistic elements include at least one of the keywords.

15. The computer-implemented method of claim 13, further comprising:
obtaining, using the at least one processor, process data and composition data associated with the first trained machine-learning or artificial-intelligence process;
based on the composition data, generating, using the at least one processor, an input dataset comprising the classification code and at least a subset of the keywords; and
using the at least one processor, applying the first trained machine-learning or artificial-intelligence process to the input dataset in accordance with the process data.

16. The computer-implemented method of claim 12, further comprising:
storing, using the at least one processor, the request data within a corresponding portion of a data repository;
determining, using the at least one processor, that the output data is inconsistent with the at least one compliance criterion; and
based on the determination that the output data is inconsistent with the at least one compliance criterion, performing operations, using the at least one processor, that request and receive one or more elements of the additional data from a computing system; and
storing, using the at least one processor, the one or more elements of the additional data within the corresponding portion of the data repository.

17. The computer-implemented method of claim 12, further comprising transmitting, using the at least one processor, a notification indicative of the provisioned product to the device, the device being configured to present at least a portion of the notification within a digital interface.

18. The computer-implemented method of claim 12, wherein:
the output data comprises a numerical value indicative of the predicted likelihood that the activity complies with the restriction;
the compliance criterion comprises a threshold value; and
the computer-implemented method further comprises:
determining, using the at least one processor, that the numerical value exceeds the threshold value; and
determining, using the at least one processor, that the output data is inconsistent with the at least one compliance criterion based on the determination that the numerical value exceeds the threshold value.

19. The computer-implemented method of claim 12, further comprising:
determining, using the at least one processor, that the output data is consistent with the at least one compliance criterion; and
based on the determination that the output data is consistent with the at least one compliance criterion, determining that the activity complies with the restriction using the at least one processor.

20. A tangible, non-transitory computer-readable medium storing instructions that, when executed by at least one processor, cause the at least one processor to perform a method, comprising:
receiving request data from a device, the request data comprising application data associated with a product and compliance data characterizing an activity, and the compliance data comprising a classification code and textual content;
based on an application of a first trained machine-learning or artificial-intelligence process to the classification code and to at least a portion of the textual content, generating output data characterizing a predicted likelihood that the activity complies with a restriction associated with the product; and
when the output data is inconsistent with at least one compliance criterion, determining a compliance of the activity with the restriction based on additional data associated with the activity, and based on the determined compliance, performing operations that that provision the product in accordance with at least a portion of the application data.
